(19) United States
(12) Patent Application Publication
(10) Pub. No.: US 2024/0342934 A1
(43) Pub. Date: Oct. 17, 2024

(54) DEPILATORY DEVICE

(71) Applicant: Panasonic Intellectual Property Management Co., Ltd., Osaka (JP)

(72) Inventors: KENICHI MURAKI, Shiga (JP); DAISUKE SONE, Hyogo (JP)

(21) Appl. No.: 18/627,494

(22) Filed: Apr. 5, 2024

(30) Foreign Application Priority Data
Apr. 14, 2023 (JP) 2023-066716

(51) Int. Cl. B26B 19/04; B26B 19/38

(52) U.S. Cl. CPC B26B 19/04; B26B 19/3833

(57) ABSTRACT

The present disclosure provides a depilatory device that can be further downsized. Depilatory device according to the present disclosure includes main body, a blade part provided at main body and capable of removing hair, and motor built in main body and drives blade part. In addition, first space in which battery capable of supplying electric power to motor is disposed is formed in main body. First space has a shape elongated in a first direction extending in a horizontal direction in a state where the blade part and main body are lined up in an up-down direction, and motor is built in main body in a state of being elongated in a direction extending in the horizontal direction.

### BACKGROUND

### 1. Technical Field

The present disclosure relates to a depilatory device.

### 2. Description of the Related Art

In the related art, as disclosed in PTL 1, an electric razor (that is, an example of a depilatory device) that includes a main body and a blade part capable of removing hair, and is capable of cutting hair such as beard (that is, an example of “depilatory”) by bringing the blade part into sliding contact with skin of a user or the like while the main body is gripped with a hand has been known.

### CITATION LIST

### Patent Literature

PTL 1: Unexamined Japanese Patent Publication No. 2013-085870

### SUMMARY

In such a depilatory device, it is preferable that downsizing is further achieved.

Therefore, an object of the present disclosure is to obtain a depilatory device that can be further downsized.

A depilatory device according to an aspect of the present disclosure includes a main body, a blade part that is provided at the main body, the blade part being configured to remove hair, and a motor that is built in the main body and drives the blade part. A first space in which a battery configured to supply electric power to the motor is disposed is provided in the main body, the first space has a shape elongated in a first direction extending in a horizontal direction in a state where the blade part and the main body are lined up in an up-down direction, and the motor is built in the main body in a state of being elongated in a direction extending in the horizontal direction.

According to the present disclosure, it is possible to obtain the depilatory device that can be further downsized.

### BRIEF DESCRIPTION OF THE DRAWINGS

FIG. 1 is a perspective view of an electric razor as an example of a depilatory device as viewed from above on a front side;

FIG. 2 is a perspective view of the electric razor as viewed from above on a back side;

FIG. 3 is a front view illustrating the electric razor;

FIG. 4 is a side view illustrating the electric razor;

FIG. 5 is a perspective view of a state where a protective cap is removed from a device main body as viewed from above on the front side;

FIG. 6 is a perspective view of a state where the protective cap is removed from the device main body as viewed from below on the back side;

FIG. 7 is a diagram schematically illustrating a state where the device main body of the electric razor is mounted on a palm;

FIG. 8 is a diagram schematically illustrating a state where the device main body of the electric razor is gripped to be wrapped with a hand;

FIG. 9 is a diagram schematically illustrating an example of a method of using the electric razor;

FIG. 10 is a diagram schematically illustrating another example of the method of using the electric razor;

FIG. 11 is a partially exploded view of the device main body of the electric razor, and is a perspective view of a state where an outer blade block is removed from a housing as viewed from above on the front side;

FIG. 12 is a partially exploded view of the outer blade block, and is a perspective view of a state where an outer blade cassette is removed from an upper base housing as viewed from above on the front side;

FIG. 13 is a partially exploded view illustrating the device main body of the electric razor, and is a perspective view of a state where a base is disassembled into a base main body and an upper base housing and a blade part is disassembled into an outer blade cassette and a slit inner blade as viewed from above on a front side;

FIG. 14 is a partially exploded view of the base main body, and is a perspective view of a state where a waterproof unit, a switch button, and a USB cap are removed from a lower base housing as viewed from above on the front side;

FIG. 15 is a partially exploded view of the base main body, and is a perspective view of a state where the waterproof unit, the switch button, and the USB cap are removed from the lower base housing as viewed from below on the back side;

FIG. 16 is a perspective view of the waterproof unit disassembled into a lower unit and an upper unit as viewed from above on the front side;

FIG. 17 is a perspective view of the waterproof unit disassembled into the lower unit and the upper unit as viewed from below on the back side;

FIG. 18 is a partially exploded view of the lower unit, and is a perspective view of a state where internal components are removed from a lower housing as viewed from above on the front side;

FIG. 19 is a partially exploded view of the lower unit, and is a perspective view of a state where the internal components are removed from the lower housing as viewed from below on the back side;

FIG. 20 is an exploded perspective view of the internal components of the lower unit as viewed from above on the front side;

FIG. 21 is an exploded perspective view of the internal components of the lower unit as viewed from below on the back side;

FIG. 22 is an exploded perspective view of a main circuit unit of the lower unit as viewed from above on the front side;

FIG. 23 is an exploded perspective view of the main circuit unit of the lower unit as viewed from below on the back side;

FIG. 24 is an exploded perspective view of a sub-circuit unit of the lower unit as viewed from above on the front side;

FIG. 25 is an exploded perspective view of the sub-circuit unit of the lower unit as viewed from below on the back side;

FIG. 26 is an exploded perspective view of a USB circuit unit of the lower unit as viewed from above on the front side;

FIG. 27 is an exploded perspective view of the USB circuit unit of the lower unit as viewed from below on the back side;

FIG. 28 is an exploded perspective view of the upper unit as viewed from above on the front side;

FIG. 29 is an exploded perspective view of the upper unit as viewed from below on the back side;

FIG. 30 is an exploded perspective view of a linear motor of the upper unit as viewed from above on the front side;

FIG. 31 is an exploded perspective view of the linear motor of the upper unit as viewed from below on the back side;

FIG. 32 is a side view illustrating the linear motor of the upper unit;

FIG. 33 is a diagram schematically illustrating an example of a method for charging the electric razor;

FIG. 34 is an exploded perspective view of the protective cap as viewed from above on the front side;

FIG. 35 is an exploded perspective view of the protective cap as viewed from below on the back side;

FIG. 36 is a cross-sectional view of the electric razor taken along a plane perpendicular to a front-back direction;

FIG. 37 is a cross-sectional view of the electric razor taken along a plane perpendicular to a width direction;

FIG. 38 is a cross-sectional view of the electric razor from which a battery is removed taken along the plane perpendicular to the front-back direction;

FIG. 39 is a cross-sectional view of the electric razor from which the battery is removed taken along the plane perpendicular to the width direction;

FIG. 40 is an enlarged cross-sectional view illustrating a slit portion in FIG. 37;

FIG. 41 is a diagram for explaining a positional relationship between centers of gravity of the outer blade cassette, the linear motor, and the battery;

FIG. 42 is a diagram schematically illustrating a method for disposing batteries according to a first modification;

FIG. 43 is a diagram schematically illustrating a method for disposing batteries according to a second modification;

FIG. 44 is a diagram schematically illustrating a method for disposing batteries according to a third modification;

FIG. 45 is a diagram schematically illustrating a method for disposing batteries according to a fourth modification; and

FIG. 46 is a diagram schematically illustrating a method for disposing batteries according to a fifth modification.

### DETAILED DESCRIPTIONS

Hereinafter, an exemplary embodiment will be described in detail with reference to the drawings. However, unnecessarily detailed description may be omitted. For example, a detailed description of already well-known matters or a redundant description of substantially the same configuration may be omitted.

Note that, the attached drawings and the following description are provided for those skilled in the art to fully understand the present disclosure, and are not intended to limit the subject matter as described in the appended claims.

In addition, in the following exemplary embodiment, an electric razor that cuts beard (that is, an example of hair) of a user or the like is used as an example of a depilatory device. In addition, in the following exemplary embodiment, a palm-in shaver is used as an example of the electric razor. Here, the palm-in shaver refers to a small shaver that fits in a palm of the user, that is, an electric razor that can be used in a state where a main body is wrapped in the palm.

In addition, in the following exemplary embodiment, a direction in which a plurality of blade blocks are provided in parallel is described as an X direction, and a direction in which each blade block extends is described as a Y direction. In the present specification, the X direction is also referred to as a second direction, a front-back direction, or a shaving direction. In the present specification, the Y direction is also referred to as a first direction, a left-right direction, or a width direction. An up-down direction in a state where the electric razor is disposed such that a blade part is positioned at an upper portion and the main body is positioned at a lower portion is described as a Z direction. In the present specification, the Z direction is also referred to as the up-down direction.

In addition, in the following exemplary embodiment, a side to which a USB cap is attached is defined as a rear side (that is, a rear side in the X direction) of the electric razor.

### Exemplary Embodiment

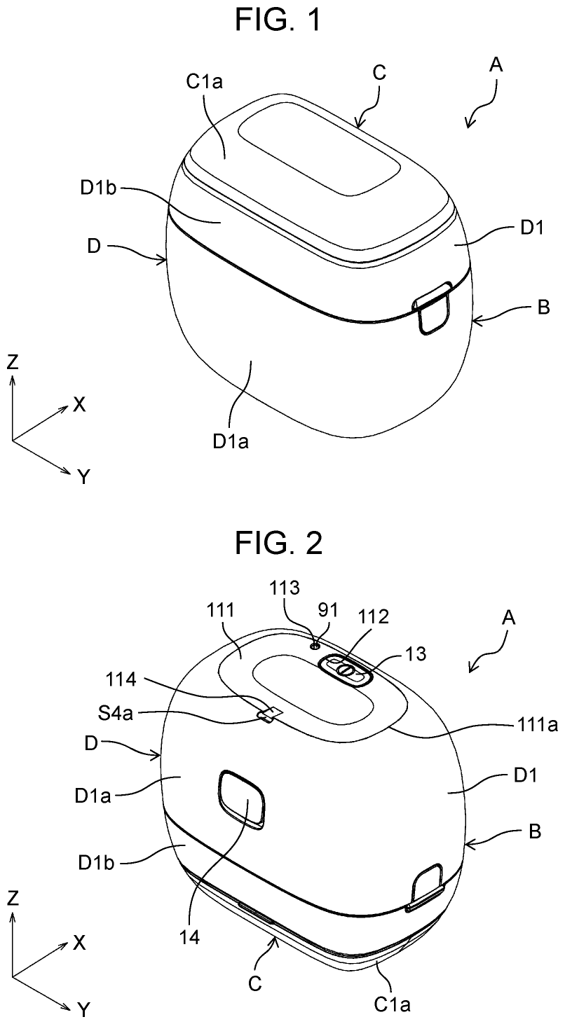

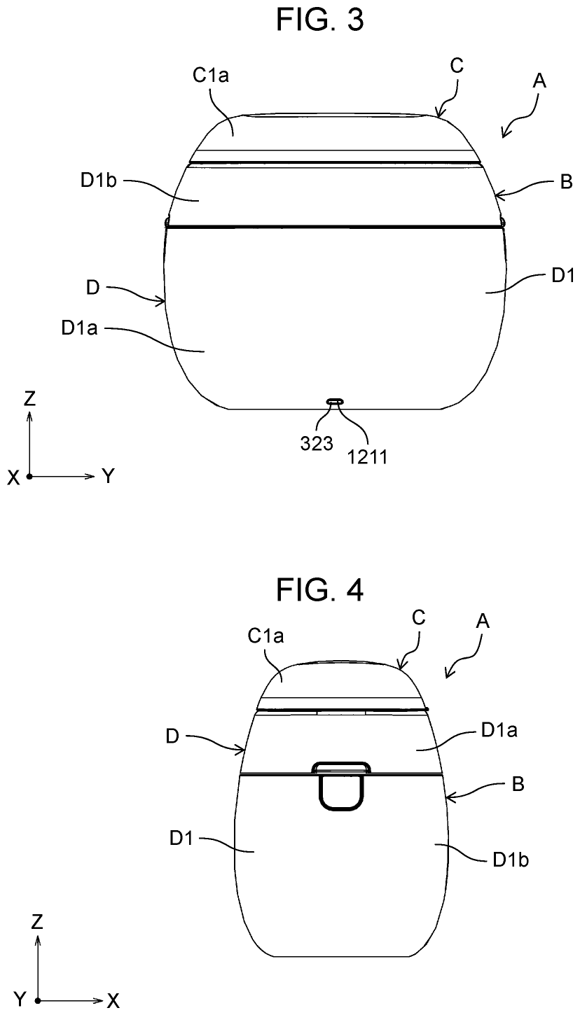

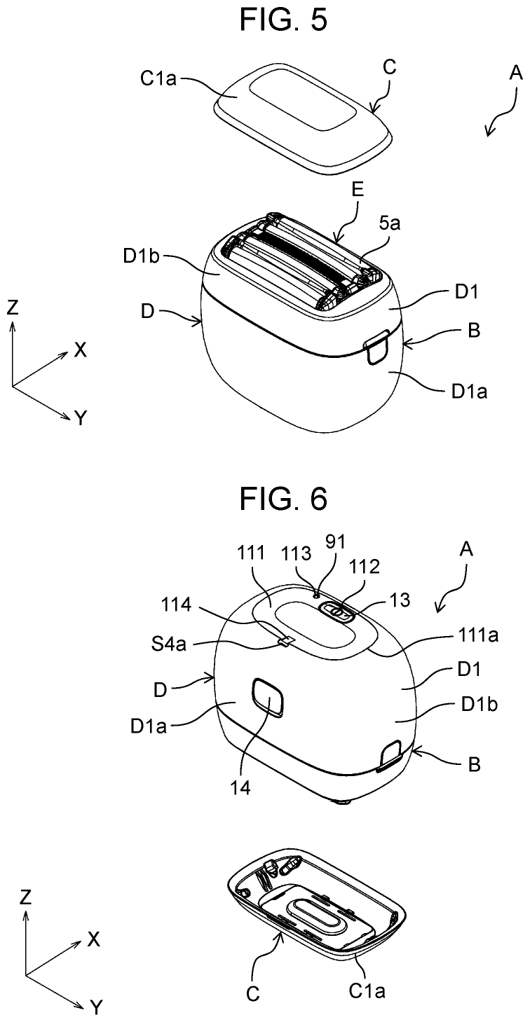

FIG. 1 is a perspective view of electric razor A as an example of a depilatory device as viewed from above on a front side. FIG. 2 is a perspective view of electric razor A as viewed from above on a back side. FIG. 3 is a front view illustrating electric razor A. FIG. 4 is a side view illustrating electric razor A. FIG. 5 is a perspective view of a state where protective cap C is removed from device main body B as viewed from above on the front side. FIG. 6 is a perspective view of a state where protective cap C is removed from device main body B as viewed from below on the back side. As illustrated in FIGS. 1 to 6, electric razor A (that is, an example of the depilatory device) according to the present exemplary embodiment includes device main body B having base D (that is, an example of the main body) and blade part E that is provided at base D in a state where a part thereof (for example, skin contact surface 5a) is exposed and that is capable of cutting beard (that is, an example of hair) (that is, an example of “hair removal”). In addition, electric razor A includes protective cap C that is detachably attached to device main body B to protect blade part E.

As described above, in the present exemplary embodiment, protective cap C can be attached to device main body B when electric razor A is not in use. In this way, blade part E is protected from being exposed to an outside, and thus, blade part E is protected.

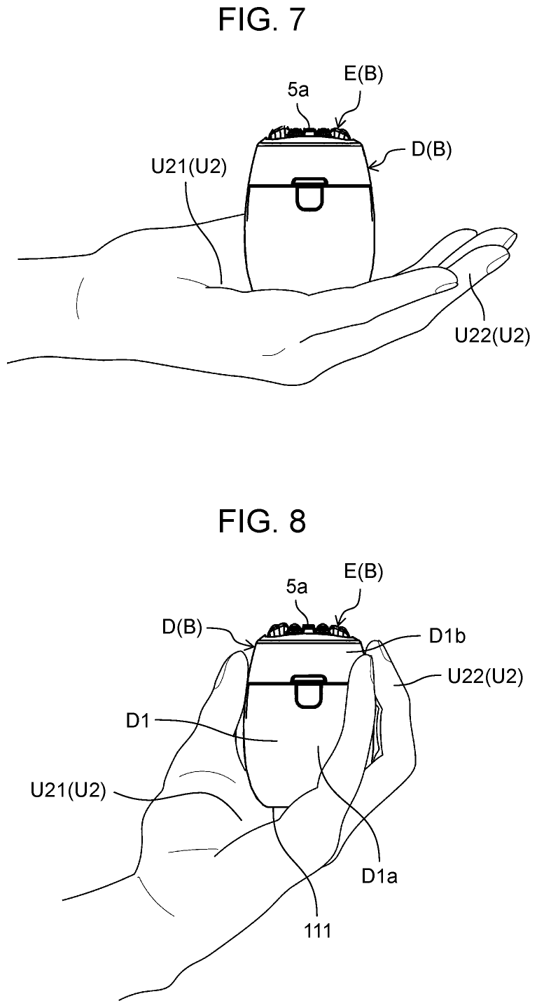

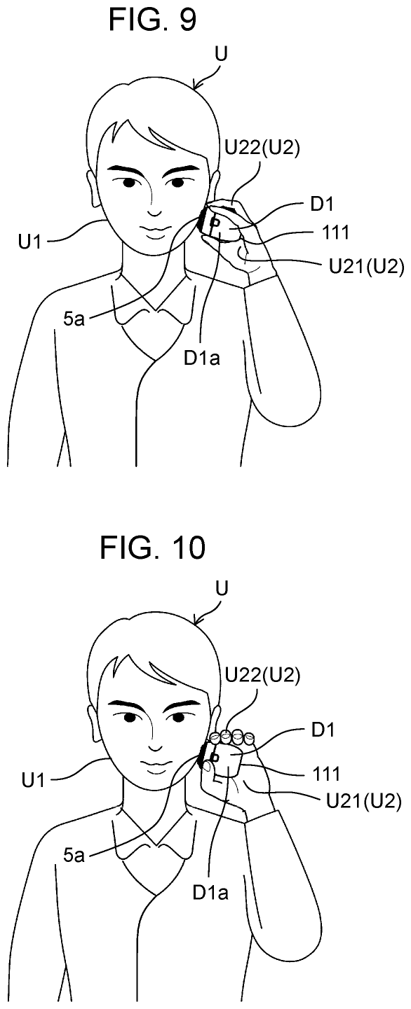

FIG. 7 is a diagram schematically illustrating a state where device main body B of electric razor A is placed on the palm. FIG. 8 is a diagram schematically illustrating a state where device main body B of electric razor A is gripped to be wrapped with the hand. FIG. 9 is a diagram schematically illustrating an example of a method of using electric razor A. FIG. 10 is a diagram schematically illustrating another example of the method of using electric razor A. When electric razor A is in use, as illustrated in FIGS. 7 to 10, protective cap C is removed from device main body B to expose a part of blade part E to the outside, and the part of blade part E exposed to the outside is brought into sliding contact with skin U1 of user U. In this way, beard (that is, an example of hair) of user U is cut (that is, an example of “hair removal”).

In addition, in the present exemplary embodiment, blade part E is driven by using linear motor 43 (that is, an example of a motor) built in base D (that is, an example of the main body). Battery 34 is disposed on base D (that is, an example of the main body), and thus, electric power is supplied from battery 34 to linear motor 43 (that is, an example of the motor).

Here, in the present exemplary embodiment, appearances of a top wall portion and a peripheral wall portion of electric razor A are formed into a smoothly curved shape such that a central portion thereof bulges as a whole.

Specifically, outer surface C1a of protective cap C is a curved surface protruding upward. Note that, in the present exemplary embodiment, a radius of curvature of a top surface portion of outer surface C1a is larger than a radius of curvature of a peripheral surface portion, and the top surface portion of outer surface C1a is a curved surface close to a horizontal plane.

In a state where protective cap C is attached to device main body B, the peripheral surface portion of outer surface C1a of protective cap C and outer surface D1a of peripheral wall D1 of base D is substantially accorded with one smoothly continuous curved surface. That is, in a state where protective cap C is attached to device main body B, the peripheral surface portion of outer surface C1a of protective cap C and outer surface D1a of peripheral wall D1 of base D constitute a part of one curved surface.

In addition, in the present exemplary embodiment, electric razor A is formed such that a length in the X direction (that is, the second direction, the front-back direction, and the shaving direction) is short (that is, a thickness is thin) and a length in the Y direction (that is, the first direction, the left-right direction, and the width direction) is long (that is, a width is wide).

Accordingly, in the present exemplary embodiment, a flat curved surface body having a small thickness in the X direction (that is, front-back direction) is formed in a state where protective cap C is attached to device main body B.

A shape of electric razor A is a shape described above, and thus, designability (that is, design property) of electric razor A (more specifically, device main body B and base D) is improved.

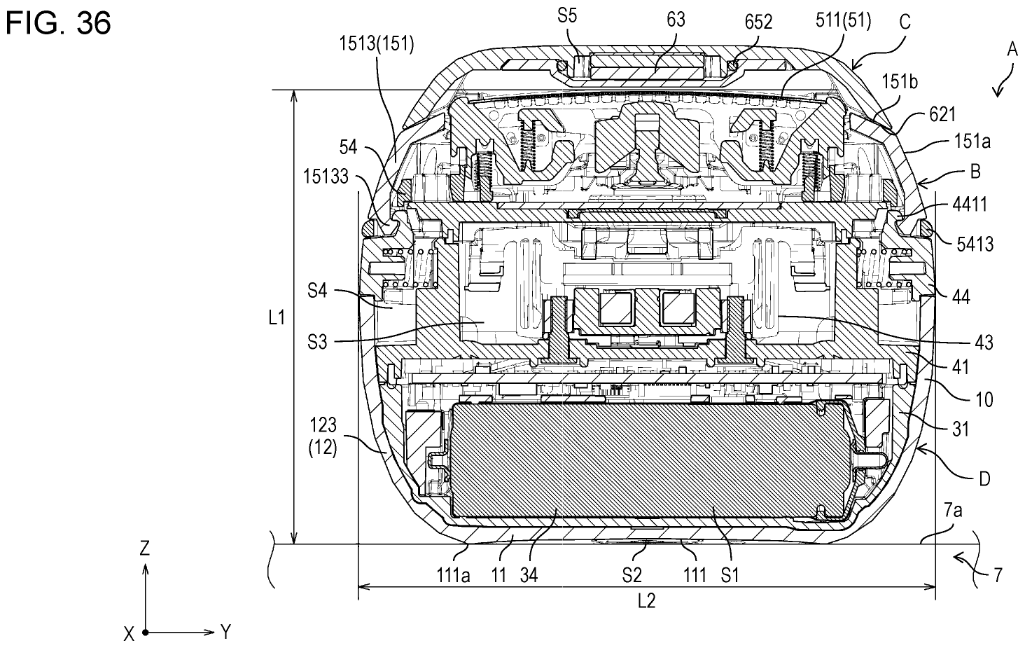

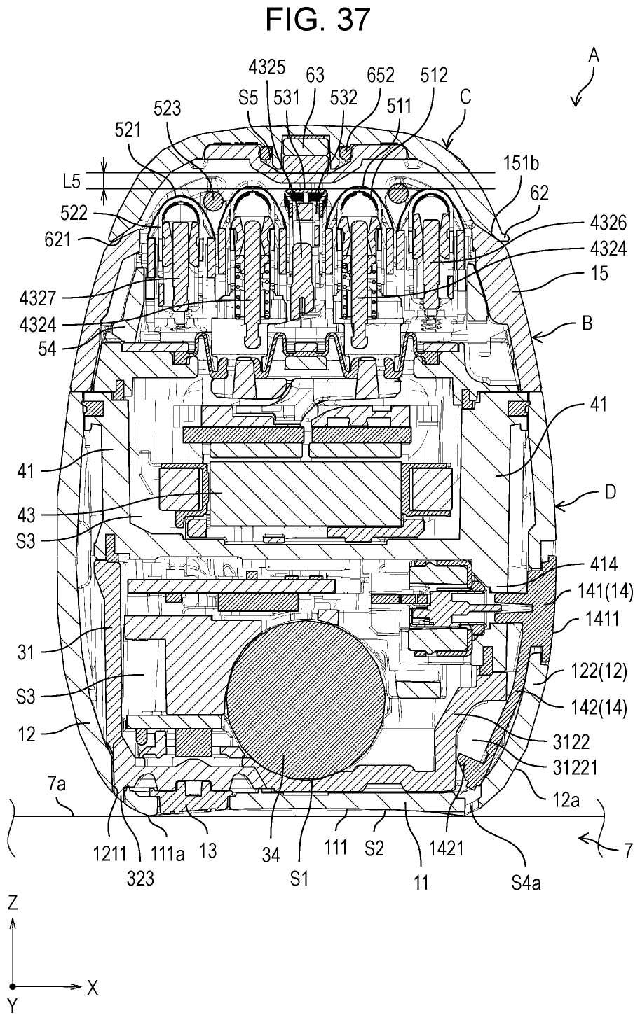

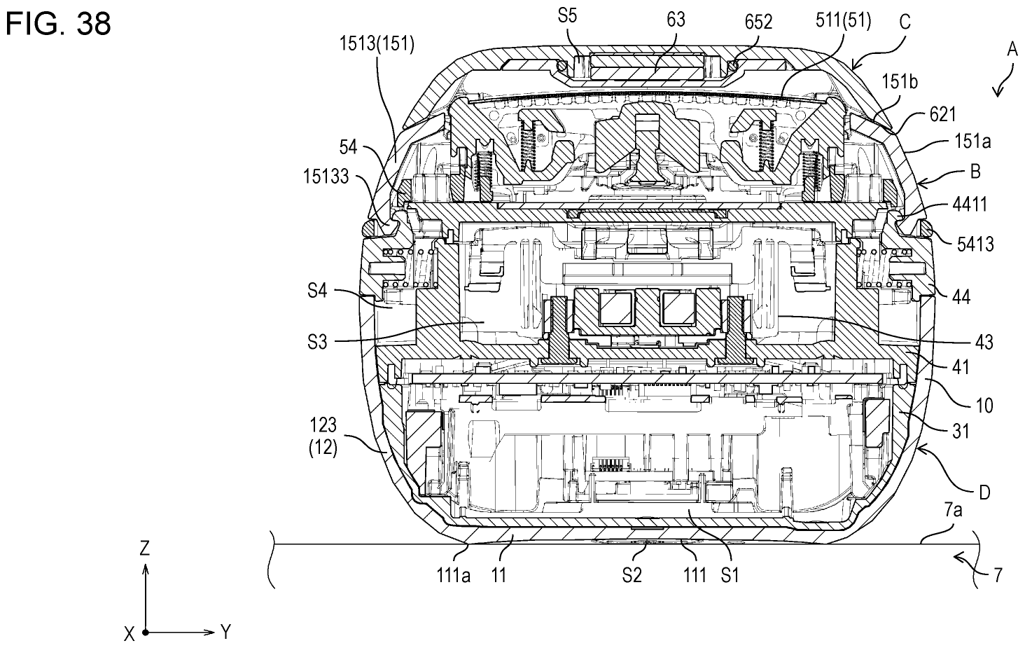

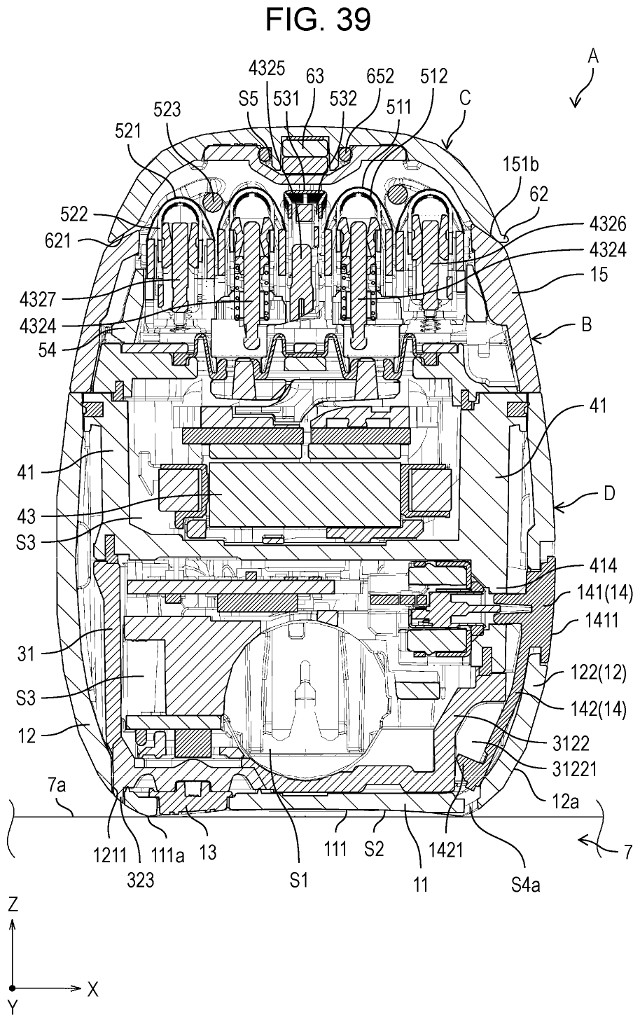

FIG. 36 is a cross-sectional view of electric razor A taken along a plane perpendicular to the front-back direction. FIG. 37 is a cross-sectional view of electric razor A taken along a plane perpendicular to the width direction. FIG. 38 is a cross-sectional view of electric razor A from which battery 34 is removed taken along a plane perpendicular to the front-back direction. FIG. 39 is a cross-sectional view of electric razor A from which battery 34 is removed taken along the plane perpendicular to the width direction. In the present exemplary embodiment, as illustrated in FIGS. 36 to 39, electric razor A can stand by itself. That is, electric razor A can be disposed without using an auxiliary member or the like in a state where blade part E is positioned at an upper portion. Specifically, a bottom surface portion of electric razor A is prevented from bulging outward, and at least a part of the bottom surface portion is brought into contact with mounting surface 7a of mounting unit 7 such as a desk, and thus, electric razor A or device main body B can stand on mounting surface 7a in a state where blade part E is positioned on the upper portion.

In the present exemplary embodiment, the bottom surface portion of electric razor A is a recessed curved surface which is recessed upward, and electric razor A or device main body B can stand on mounting surface 7a by bringing a peripheral edge portion of the bottom surface portion of electric razor A into contact with mounting surface 7a.

Note that, as illustrated in FIG. 7, electric razor A or device main body B can stand on palm U21 of user U in a state where blade part E is positioned on the upper portion.

As described above, since electric razor A according to the present exemplary embodiment has excellent designability and can stand on mounting surface 7a, when electric razor A is not used, the electric razor can be decorated as an interior of a room.

For example, electric razor A can be disposed as the interior on mounting unit 7 such as the desk in the room. In this way, when the user does some work in the room, in a case where the user wants to use electric razor A, since the user does not need to move to a place where the electric razor is generally stored, such as a wash basin, the user can use electric razor A more easily. Then, when the user finishes using the electric razor, the electric razor can be decorated as the interior of the room.

In addition, in the present exemplary embodiment, as illustrated in FIG. 36, device main body B has length L1 (that is, a height of device main body B) in the Z direction (that is, up-down direction) shorter than length L2 (that is, a width) in the Y direction (that is, width direction). As described above, in the present exemplary embodiment, device main body B has a large width. In this way, device main body B can stand by itself in a more stable state.

In addition, a height dimension of device main body B is reduced, and thus, as illustrated in FIG. 8, a fingertip can be brought closer to skin contact surface 5a of blade part E when outer surface D1a of peripheral wall D1 of base D is held by finger U22 while a lower end side (for example, bottom surface 111) of base D faces palm U21.

Then, the fingertip is brought closer to skin contact surface 5a of blade part E, and thus, base D can be held in a more stable state when outer surface D1a of peripheral wall D1 of base D is held by finger U22 while the lower end side (for example, bottom surface 111) of base D faces palm U21. That is, electric razor A can be used without shaking even in a case where electric razor A is used in a state where outer surface D1a of peripheral wall D1 of base D is held by finger U22 while the lower end side (for example, bottom surface 111) of base D faces palm U21.

As described above, in the present exemplary embodiment, even in a case where electric razor A is used in a state where base D is wrapped with hand U2 from the bottom surface side (for example, a state illustrated in FIG. 8), deterioration of operability can be suppressed.

Accordingly, electric razor A according to the present exemplary embodiment can be used in a state where base D is gripped by various methods. For example, as illustrated in FIG. 9, electric razor A can be used in a state where base D is wrapped with hand U2 from the bottom surface side. That is, electric razor A can be used in a state where outer surface D1a of peripheral wall D1 of base D is held by finger U22 while the lower end side of base D faces palm U21. In addition, as illustrated in FIG. 10, electric razor A may be also used in a state where peripheral wall D1 of base D is gripped with palm U21. That is, electric razor A may be used in a state where palm U21 and finger U22 are brought into contact with outer surface D1a of peripheral wall D1 of base D.

Note that, in the present exemplary embodiment, a size of base D is set such that the fingertip is positioned near skin contact surface 5a of blade part E (for example, base D) when a general adult male holds outer surface D1a of peripheral wall D1 of base D with finger U22 while the lower end side (for example, bottom surface 111) of base D faces palm U21.

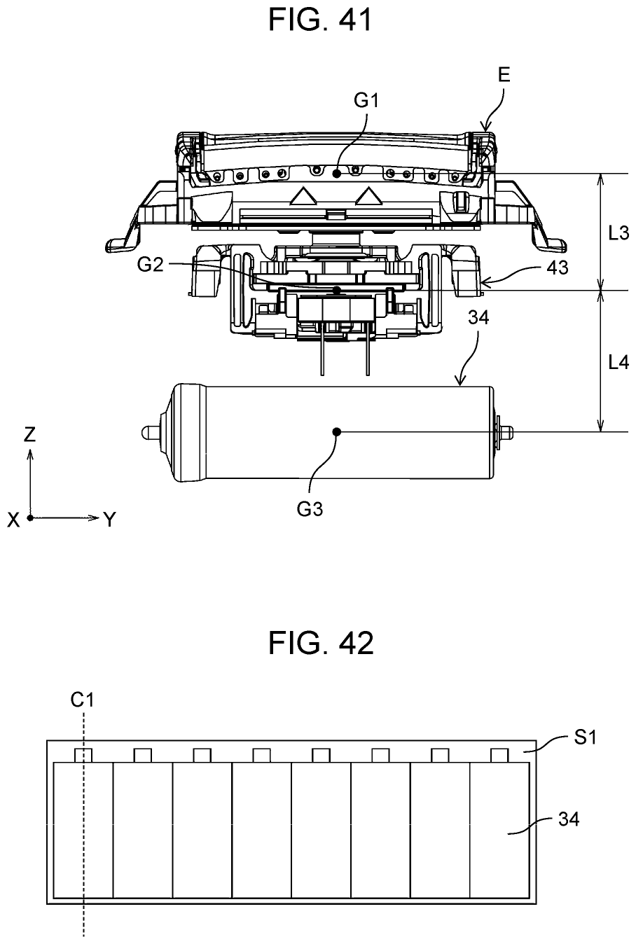

FIG. 41 is a diagram for explaining a positional relationship between centers of gravity of outer blade cassette 50, linear motor 43, and battery 34. In the present exemplary embodiment, as illustrated in FIG. 41, blade part E, linear motor 43, and battery 34 are disposed to be lined up in the Z direction (that is, the up-down direction). In the present exemplary embodiment, distance L4 from center of gravity G3 of battery 34 to center of gravity G2 of linear motor 43 is set to be larger (that is, longer) than distance L3 from center of gravity G1 of blade part E to center of gravity G2 of linear motor 43.

Note that, distance L4 from center of gravity G3 of battery 34 to center of gravity G2 of linear motor 43 may be set to be substantially the same distance as distance L3 from center of gravity G1 of blade part E to center of gravity G2 of linear motor 43. In this way, when peripheral wall 12 of base D is held by finger U22 in a state where the lower end side (for example, bottom surface 111) of base D faces palm U21, a center of gravity of device main body B can be positioned closer to palm U21 than the fingertip. That is, base D can be gripped in a state where the center of gravity of device main body B is positioned in hand U2.

Thus, in a case where electric razor A is used in a state where base D is wrapped with hand U2, it is possible to more reliably suppressing shaking of electric razor A, and it is possible to more easily bring blade part E into contact with a target place. That is, operability of electric razor A (more specifically, device main body B) can be further improved.

Further, distance L4 from center of gravity G3 of battery 34 to center of gravity G2 of linear motor 43 can be set to be smaller (that is, shorter) than distance L3 from center of gravity G1 of blade part E to center of gravity G2 of linear motor 43. In this way, the operability of electric razor A (more specifically, device main body B) can be further improved. In addition, when distance LA from center of gravity G3 of battery 34 to center of gravity G2 of linear motor 43 is set as short as possible, the center of gravity of device main body B can be brought closer to blade part E. As described above, when the center of gravity of device main body B is brought closer to blade part E, there is an advantage that electric razor A (more specifically, device main body B) is more easily operated.

Next, an outline of a configuration of device main body B according to the present exemplary embodiment will be described.

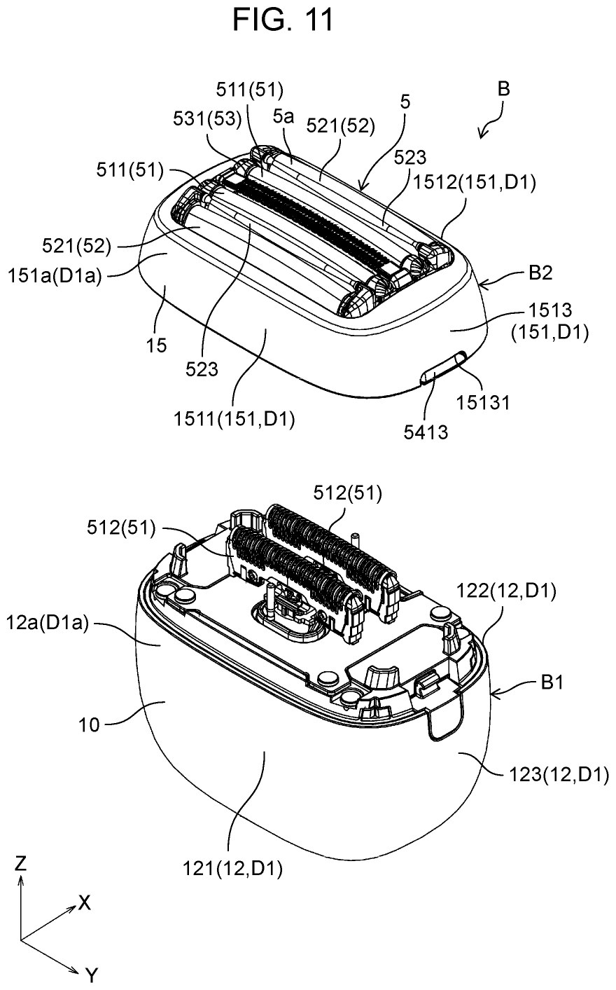

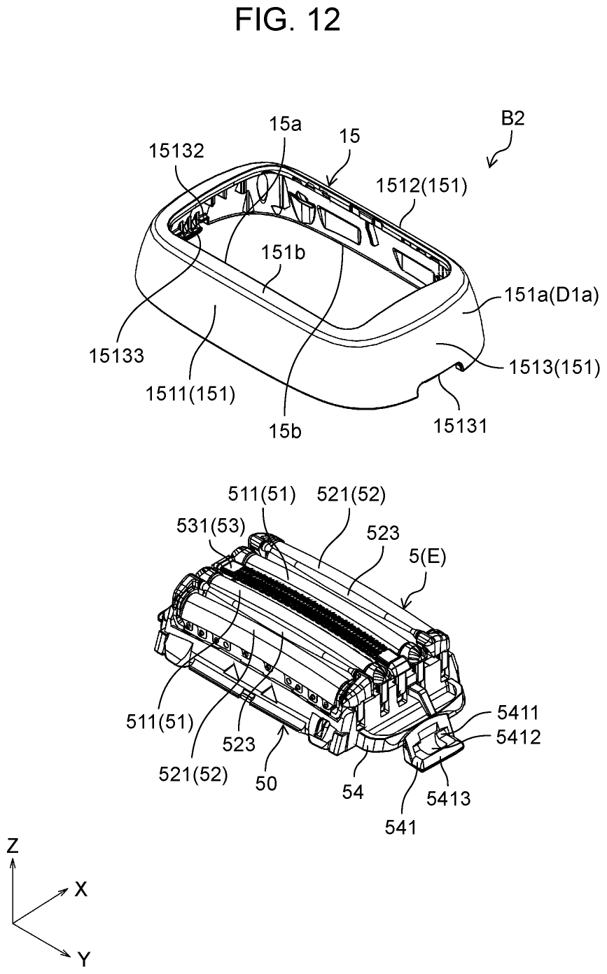

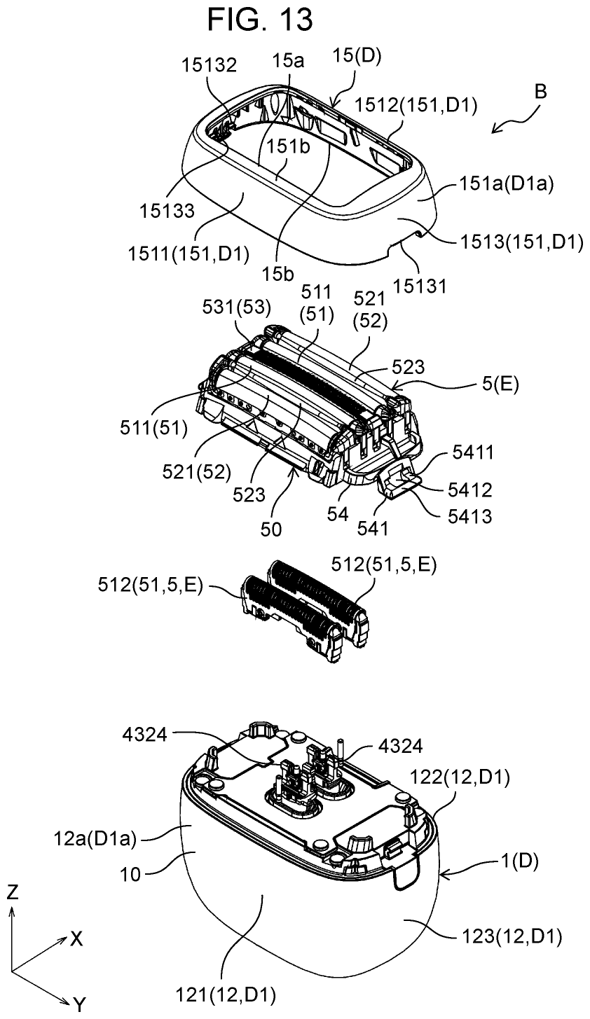

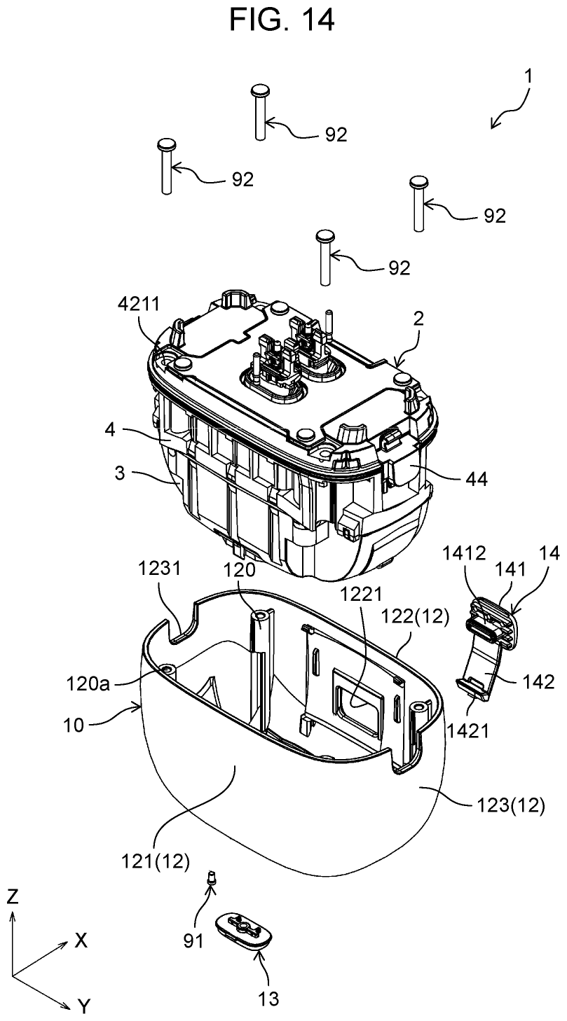

FIG. 11 is a partially exploded view of device main body B of electric razor A, and is a perspective view of a state where outer blade block B2 is removed from housing B1 as viewed from above on the front side. FIG. 12 is a partially exploded view of outer blade block B2, and is a perspective view of a state where outer blade cassette 50 is removed from upper base housing 15 as viewed from above on the front side. FIG. 13 is a partially exploded view of device main body B of electric razor A, and is a perspective view of a state where base D is disassembled into base main body 1 and upper base housing 15 and blade part E is disassembled into outer blade cassette 50 and slit inner blade 532 as viewed from above on the front side. As illustrated in FIGS. 11 and 13, device main body B according to the present exemplary embodiment includes base D and blade part E that is provided at base D and is capable of cutting beard.

In addition, base D includes base main body 1 having lower base housing 10 that opens upward, and upper base housing 15 detachably attached to lower base housing 10 and capable of holding a part of blade part E (for example, outer blade cassette 50). Lower base housing 10 and upper base housing 15 can be formed by using, for example, a material such as synthetic resin or metal.

In addition, in the present exemplary embodiment, lower base housing 10 has a bottomed hollow-columnar shape that opens upward, and includes peripheral wall 12. Peripheral wall 12 is formed such that outer surface 12a is a curved surface protruding outward. On the other hand, upper base housing 15 has a hollow-columnar shape penetrating vertically, and includes peripheral wall 151 in which upper opening 15a and lower opening 15b are formed. Peripheral wall 151 is also formed such that outer surface 151a is a curved surface protruding outward.

Further, in the present exemplary embodiment, in a state where upper base housing 15 is attached to lower base housing 10, outer surface 12a of peripheral wall 12 of lower base housing 10 and outer surface 151a of peripheral wall 151 of upper base housing 15 is substantially accorded with one smoothly continuous curved surface. That is, in a state where upper base housing 15 is attached to lower base housing 10, outer surface 12a of peripheral wall 12 of lower base housing 10 and outer surface 151a of peripheral wall 151 of upper base housing 15 constitute a part of one curved surface.

Outer surface 12a of peripheral wall 12 of lower base housing 10 and outer surface 151a of peripheral wall 151 of upper base housing 15 constitute outer surface D1a of peripheral wall D1 of base D.

As described above, in the present exemplary embodiment, an appearance of peripheral wall D1 of base D (that is, a shape of outer surface D1a) has a smoothly curved shape such that a central portion thereof bulges as a whole. In this way, an external shape of base D is formed into a shape that is easily gripped by hand U2.

Specifically, in the present exemplary embodiment, user U can grip electric razor A or device main body B with hand U2 by holding outer surface D1a of peripheral wall D1 of base D with finger U22. Accordingly, in the present exemplary embodiment, as illustrated in FIGS. 1 to 6, outer surface D1a of peripheral wall D1 of base D is grip D1b that can be gripped by hand U2 of user U when electric razor A is in use (that is, when device main body B is in use).

Here, in the present exemplary embodiment, as described above, electric razor A or device main body B can be gripped with hand U2 by holding outer surface D1a of peripheral wall D1 of base D by finger U22 while the lower end side (for example, bottom surface 111) of base D faces palm U21. Then, in a case where the general adult male grips the base with the hand, the size of base D is set such that the fingertip is positioned near skin contact surface 5a of blade part E (for example, near base D).

Accordingly, when the general adult male grips electric razor A or device main body B with hand U2, a portion inclined upward and inward of outer surface D1a is held by finger U22. Specifically, a portion inclined upward and inward on one side in the X direction (that is, the second direction, the front-back direction, and the shaving direction) of outer surface D1a is held by a thumb, and a portion inclined upward and inward on the other side in the X direction is held by a finger other than the thumb. As described above, in a case where outer surface D1a of peripheral wall D1 of base D is held by finger U22 while the lower end side (for example, bottom surface 111) of base D faces palm U21, the portions inclined upward and inward of outer surface D1a on both sides in the X direction are held to be pinched by the thumb and the other finger.

In this way, user U holds base D in a state where a force for moving electric razor A or device main body B toward palm U21 acts. Thus, for example, when the user holds electric razor A or device main body B (for example, when the electric razor is in use), even though base D is pinched with a large force by the thumb and other finger, base D is moved toward palm U21. As a result, since electric razor A and device main body B are also moved toward palm U21, a state where base D fits in palm U21 is maintained.

As described above, in the present exemplary embodiment, the external shape of base D is a shape capable of suppressing falling of electric razor A or device main body B from hand U2, and thus, the base has a shape that is easily gripped by hand U2.

Note that, in the present exemplary embodiment, the external shape of base D (that is, an outer surface shape of a peripheral wall portion of base D) is formed into a smoothly curved shape as a whole, and thus, designability (that is, design property) of electric razor A (more specifically, device main body B and base D) can be enhanced.

In addition, a cavity is formed inside lower base housing 10, and various electric components such as battery 34 are accommodated within the cavity formed inside lower base housing 10.

In the present exemplary embodiment, base main body 1 includes waterproof unit 2, and various electric components such as battery 34 are accommodated within main-body-side waterproof space S3 formed inside waterproof unit 2. Waterproof unit 2 is disposed within the cavity formed inside lower base housing 10, various electric components such as battery 34 are accommodated within the cavity formed inside lower base housing 10. In this way, device main body B (that is, one element of electric razor A) has a waterproof function.

On the other hand, blade part E is detachably held on peripheral wall 151 of upper base housing 15. In the present exemplary embodiment, blade part E is detachably held on peripheral wall 151 of upper base housing 15 by forming blade unit 5 having blade part E and detachably attaching blade unit 5 to peripheral wall 151 of upper base housing 15. At this time, blade unit 5 is held by peripheral wall 151 of upper base housing 15 in a state where a part of blade part E is exposed to the outside. In this way, a portion of blade part E exposed to the outside of peripheral wall 151 of upper base housing 15 functions as skin contact surface 5a that comes into contact with skin U1 of user U or the like when electric razor A (that is, an example of the depilatory device) is in use (that is, when device main body B is in use).

Next, a specific configuration of blade unit 5 will be described.

As illustrated in FIGS. 11 to 13, blade unit 5 includes five blade blocks, and outer blade case 54. The five blade blocks are disposed to be lined up in the X direction in a state where longitudinal directions thereof is accorded with the Y direction.

As described above, in the present exemplary embodiment, each of the blade blocks has a predetermined length and width, and these blade blocks are disposed in a state where the width directions thereof is substantially accorded with the X direction (that is, the second direction, the front-back direction, or the shaving direction) of electric razor A while the length directions thereof are substantially accorded with the Y direction (that is, the first direction or the left-right direction) of electric razor A.

In the present exemplary embodiment, five blade blocks include two net blade blocks 51, two finishing net blade blocks 52, and one slit blade block 53.

Note that, net blade block 51 principally has a function of cutting off beard in a fallen state (that is, an example of body hair) and beard in a short standing state (that is, an example of body hair). In addition, finishing net blade block 52 principally has a deep shaving function of cutting off short beard (that is, an example of body hair). Slit blade block 53 principally has a function of cutting off thin long beard (that is, an example of body hair).

In the present exemplary embodiment, as illustrated in FIG. 11, one slit blade block 53 is disposed at a center in the X direction and two net blade blocks 51 are disposed on sides across slit blade block 53. Two finishing net blade blocks 52 are disposed on sides of each net blade block 51. That is, two finishing net blade blocks 52 are disposed at both ends in the X direction in a state where two net blade blocks 51 and one slit blade block 53 are interposed therebetween.

As illustrated in FIG. 13, net blade block 51 includes net blade 511 and net inner blade 512. In the present exemplary embodiment, net blade 511 is formed by being curved in an inverted U-shape protruding upward in side view (that is, in a state viewed along the Y direction).

Further, net blade 511 is formed by being slightly curved in the Y direction (that is, in outer blade length direction) to protrude upward in front view (that is, in a state viewed along the X direction). For example, many circular blade holes (not illustrated) are formed in net blade 511. Note that, net blade 511 may be formed without being curved to protrude upward in front view. For example, in a state where net blade 511 is viewed from the front (that is, in a state viewed in the X direction), a top of net blade 511 can be a straight line extending in the Y direction (that is, outer blade length direction).

Net inner blade 512 has an inverted U-shape along a curved shape of net blade 511, and is disposed inside net blade 511 (more specifically, below net blade 511, and here, on a side opposite to a side of net blade 511 in contact with the skin). As illustrated in FIG. 37, these two net inner blades 512 are detachably attached to a pair of drivers 4324. In this case, two net inner blades 512 are detachably attached to the pair of drivers 4324 in a state of being biased upward. When a power supply of electric razor A is turned on to drive driver 4324 in a state where net inner blade 512 is disposed inside net blade 511 while being attached to driver 4324, net inner blade 512 is displaced relative to net blade 511 (that is, is relatively moved, more specifically, reciprocates in the Y direction) while being in sliding contact with an inner surface of net blade 511.

As illustrated in FIG. 37, finishing net blade block 52 includes finishing net blade 521 and finishing net inner blade 522. In the present exemplary embodiment, finishing net blade 521 is formed by being curved in an inverted U-shape protruding upward in side view (that is, in a state viewed along the Y direction).

Further, finishing net blade 521 is formed by being slightly curved along the Y direction (that is, outer blade length direction) to be convex upward in a front view (that is, in a state viewed in the X direction). For example, many circular blade holes (not illustrated) are formed in finishing net blade 521. Note that, finishing net blade 521 may be formed without being curved to protrude upward in front view. For example, in a state where finishing net blade 521 is viewed from the front (that is, in a state viewed in the X direction), a top of finishing net blade 521 may be a straight line extending in the Y direction (that is, outer blade length direction).

In addition, in the present exemplary embodiment, a blade width of finishing net blade 521 in the X direction (that is, front-back direction) is set to be smaller than a blade width of net blade 511 in the X direction (that is, front-back direction). As described above, the blade width of finishing net blade 521 is set to be smaller than the blade width of net blade 511, that is, a radius of curvature of finishing net blade 521 is set to be small. Thus, the skin pressed against a surface protrudes largely inward from the blade hole, and the beard can be shaved short.

Finishing net inner blade 522 has an inverted U-shape along a curved shape of finishing net blade 521, and is disposed inside finishing net blade 521 (more specifically, below finishing net blade 521, and here, on a side opposite to a side of finishing net blade 521 in contact with the skin). As illustrated in FIG. 37, these two finishing net inner blades 522 are detachably attached to drive pins 4326 and 4327 coupled to the pair of drivers 4324. At this time, two finishing net inner blades 522 are detachably attached to drive pins 4326 and 4327 in a state of being biased upward. When the power supply of electric razor A is turned on to drive pins 4326 and 4327 in a state where finishing net inner blades 522 are disposed inside finishing net blades 521 while being attached to drive pins 4326 and 4327, finishing net inner blades 522 are displaced relative to finishing net blades 521 (that is, are relatively moved, more specifically, reciprocate in the Y direction) while being in sliding contact with inner surfaces of finishing net blades 521.

As illustrated in FIG. 37, slit blade block 53 includes slit outer blade 531 and slit inner blade 532. In the present exemplary embodiment, slit outer blade 531 is formed by being bent in an inverted U-shape protruding upward in side view (that is, in a state viewed in the Y direction). That is, slit outer blade 531 has a substantially flat top surface.

Further, slit outer blade 531 is formed by being slightly curved along the Y direction (that is, outer blade length direction) to protrude upward in front view (that is, in a state viewed in the X direction). A plurality of blade holes each having a slit shape extending in the X direction are formed in slit outer blade 531 to be lined up in a state of being spaced apart in the Y direction. Note that, slit outer blade 531 may be formed without being curved to protrude upward in front view. For example, in a state where slit outer blade 531 is viewed from the front (that is, in a state viewed in the X direction), a top of slit outer blade 531 can be a straight line extending in the Y direction (that is, outer blade length direction). That is, slit outer blade 531 can be formed such that a top surface of slit outer blade 531 is a plane (that is, a flat surface).

Slit inner blade 532 has an inverted U-shape along a bent shape of slit outer blade 531, and is disposed inside slit outer blade 531 (more specifically, below slit outer blade 531, here, on a side opposite to a side of slit outer blade 531 in contact with the skin). As illustrated in FIG. 37, slit inner blade 532 is detachably attached to driver 4325 (that is, driver different from the driver to which net inner blade 512 is attached) coupled to one driver 4324 of the pair of drivers 4324. In this case, slit inner blade 532 is detachably attached to driver 4325 (that is, driver different from the driver to which net inner blade 512 is attached) in a state of being biased upward. When the power supply of electric razor A is turned on to drive driver 4325 in a state where slit inner blade 532 is disposed inside slit outer blade 531 while being attached to driver 4325, slit inner blade 532 is displaced relative to slit outer blade 531 (that is, is relatively moved, more specifically, reciprocates in the Y direction) while being in sliding contact with an inner surface of slit outer blade 531.

As described above, electric razor A according to the present exemplary embodiment has a form of a reciprocating-type electric razor in which net inner blade 512, finishing net inner blade 522, and slit inner blade 532 reciprocate with respect to net blade 511, finishing net blade 521, and slit outer blade 531. Accordingly, in the present exemplary embodiment, blade part E includes five outer blades (more specifically, two net blades 511, two finishing net blades 521, and one slit outer blade 531) and five inner blades (more specifically, two net inner blades 512, two finishing net inner blades 522, and one slit inner blade 532).

In the present exemplary embodiment, members other than two net inner blades 512 of five blade blocks are attached to outer blade case 54 in a substantially frame shape. At this time, the members may be detachably attached to outer blade case 54, or may be attached to outer blade case 54 in a state of being undetachable. Note that, all the members including two net inner blades 512 (more specifically, five blade blocks) may be attached to outer blade case 54 in the substantially frame shape.

In addition, in the present exemplary embodiment, two net blade blocks 51, two finishing net blade block 52, and one slit blade block 53 are attached to outer blade case 54 in a state of being allowed to be floated in the Z direction (that is, up-down direction). In this way, when upper base housing 15 to which outer blade cassette 50 is attached is attached to base main body 1, each blade block floats separately and independently with respect to base main body 1. Note that, one or more blade blocks of two net blade blocks 51, two finishing net blade blocks 52, and one slit blade block 53 may be configured not to be floated in the Z direction (that is, up-down direction).

In addition, in the present exemplary embodiment, finishing net blade block 52 includes roller 523 as a skin guard member, and roller 523 is disposed between net blade 511 and finishing net blade 521. When device main body B is in use, roller 523 is brought into contact with skin U1 to effectively prevent skin U1 from being strongly pressed against finishing net blade 521 having a small radius of curvature.

Further, in the present exemplary embodiment, as illustrated in FIGS. 11 and 13, two net blades 511 can be attached to outer blade case 54 in a state where net inner blade 512 is not disposed inward. On the other hand, as illustrated in FIGS. 13 and 37, two finishing net blades 521 are attached to outer blade case 54 in a state where finishing net inner blades 522 are disposed inward, and one slit outer blade 531 is attached to outer blade case 54 in a state where slit inner blade 532 is disposed inward. As described above, in the present exemplary embodiment, outer blade cassette 50 is formed by attaching two net blades 511, two finishing net blade blocks 52, and one slit blade block 53 to outer blade case 54. Outer blade cassette 50 is detachably attached to upper base housing 15.

Specifically, as illustrated in FIGS. 11 to 13, upper base housing 15 includes peripheral wall 151 in a substantially hollow-columnar shape in which upper opening 15a and lower opening 15b are formed, and outer blade cassette 50 with each outer blade facing upward is inserted from lower opening 15b of upper base housing 15 to attach outer blade cassette 50 to upper base housing 15. At this time, outer blade cassette 50 is attached to upper base housing 15 in a state where a surface of each outer blade is exposed from upper opening 15a of upper base housing 15. Thus, in the present exemplary embodiment, a portion of the surface of each outer blade exposed from upper opening 15a of upper base housing 15 is a portion of blade part E exposed to the outside of base D. That is, the portion of the surface of each outer blade exposed from upper opening 15a of upper base housing 15 is skin contact surface 5a that comes into contact with skin U1 of user U (hereinafter, may be referred to as a “skin surface”).

Release buttons 541 is formed at both left and right ends of outer blade case 54. By operating release buttons 541, the attachment of upper base housing 15 and outer blade cassette 50 is released.

Specifically, release button 541 includes elastic piece 5411 that extends outward and downward in the Y direction from a main body portion of outer blade case 54 and is elastically deformable in the Y direction, engagement hole 5412 that is formed at a central portion of elastic piece 5411 so as to penetrate in the Y direction, and operation portion 5413 that is formed to protrude outward in the Y direction from a lower end of elastic piece 5411.

In addition, peripheral wall 151 of upper base housing 15 includes front wall 1511, rear wall 1512, and a pair of side walls 1513 coupling front wall 1511 and rear wall 1512. Cutouts 15131 that open downward are formed at lower ends of central portions of the pair of side walls 1513 in the X direction.

Further, engagement protrusions 15132 protruding inward in the Y direction and detachably engaged with engagement holes 5412 are formed at the lower ends of the central portions of the pair of side walls 1513 in the X direction.

In this way, when outer blade cassette 50 is inserted from lower opening 15b of upper base housing 15, a distal end portion of engagement protrusion 15132 protruding inward from upper base housing 15 is engaged with engagement hole 5412 of elastic piece 5411 of outer blade case 54 from the outside. At this time, as illustrated in FIG. 36, operation portion 5413 is accommodated in cutout 15131 in a state where the distal end thereof protrudes outward in the Y direction from outer surface 151a of peripheral wall 151.

Note that, in the present exemplary embodiment, operation portion 5413 of release button 541 is provided such that the distal end thereof protrudes outward from an outer surface (specifically, outer surface 151a of peripheral wall 151) of upper base housing 15 in a state where outer blade cassette 50 is attached to upper base housing 15. Thus, when the engagement between engagement protrusions 15132 and engagement holes 5412 is released by holding operation portion 5413 of release button 541 to pinch the operation portion from the left and right and retracting the operation portion inward to bend elastic piece 5411 inward, outer blade cassette 50 is allowed to be removed from upper base housing 15.

As described above, in the present exemplary embodiment, upper base housing 15 to which outer blade cassette 50 is attached is attached to base main body 1 in a state where two net inner blades 512 are attached to drivers 4324 protruding upward from base main body 1. When upper base housing 15 to which outer blade cassette 50 is attached is attached to base main body 1 in a state where two net inner blades 512 are attached to drivers 4324, two net inner blades 512 are disposed inside corresponding net blades 511.

That is, in the present exemplary embodiment, housing B1 is formed by attaching two net inner blades 512 to drivers 4324 protruding upward from base main body 1. In addition, outer blade block B2 is formed by attaching outer blade cassette 50 to upper base housing 15. Outer blade block B2 is detachably attached to housing B1 to form device main body B.

In the present exemplary embodiment, release buttons 44 are formed on both left and right ends of base main body 1, and the attachment of housing B1 and outer blade block B2 is released by operating the pair of release buttons 44.

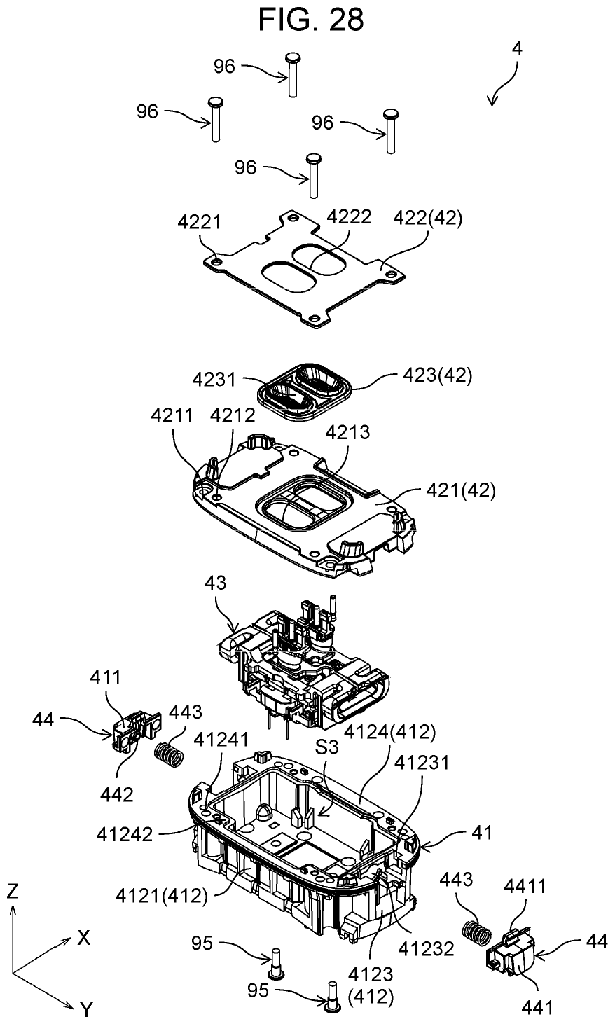

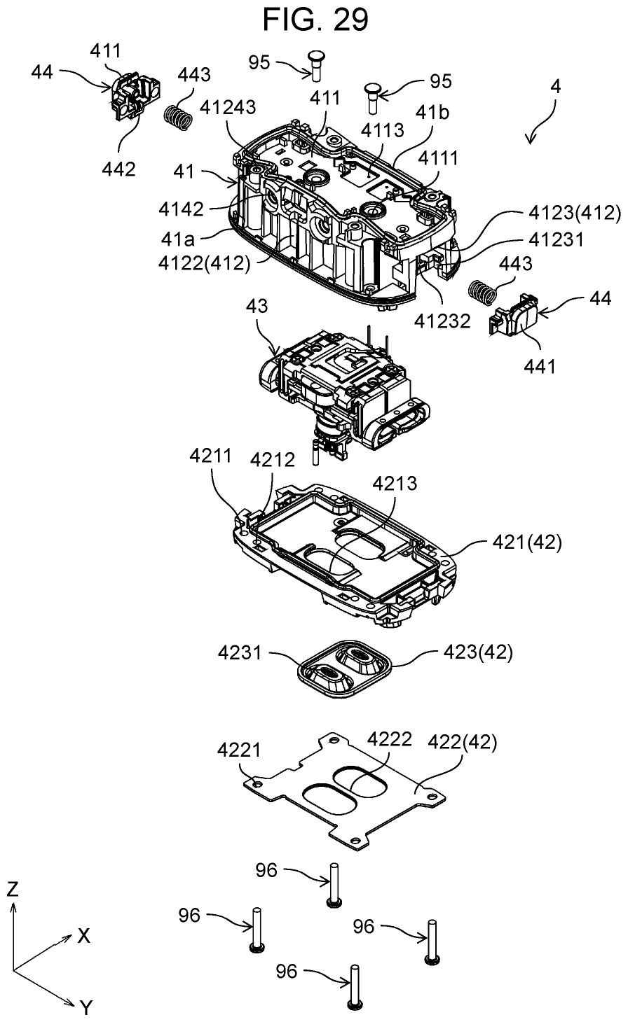

Specifically, as illustrated in FIGS. 28 and 29, the pair of release buttons 44 includes main body 441, shaft portion 442 formed at an inner center of the main body to protrude inward in the Y direction (that is, width direction), and coil spring 443 inserted into shaft portion 442 to bias main body 441 outward in the Y direction (that is, width direction). FIG. 28 is an exploded perspective view of upper unit 4 as viewed from above on the front side. FIG. 29 is an exploded perspective view of the upper unit as viewed from below on the back side.

As illustrated in FIGS. 28, 29, and 36, engagement hooks 4411 are formed in main bodies 441 of release buttons 44 to protrude upward, and engagement hooks 15133 protruding inward in the Y direction and detachably engaged with engagement hooks 4411 are formed at the lower ends of the central portions of the pair of side walls 1513 in the X direction. In the present exemplary embodiment, hook portion 44111 of engagement hook 4411 is formed to protrude outward in the Y direction (that is, width direction), and engagement hook 15133 is formed to protrude inward in the Y direction (that is, width direction). Main body 441 is biased outward in the Y direction (that is, width direction) by coil spring 443, and thus, engagement hook 4411 and engagement hook 15133 are allowed to be more firmly engaged.

Further, in the present exemplary embodiment, main body 441 is held by detachment button holding portion 41231 formed on side wall 4123 of upper housing 41 to be allowed to protrude and retract in a state of being biased in the Y direction (that is, width direction) while a distal end of coil spring 443 is brought into contact with spring receiving portion 41232 formed on side wall 4123 of upper housing 41 in a state where coil spring 443 is inserted into shaft portion 442. An operation portion of main body 441 is inserted into cutout 1231 formed in side wall 123 of lower base housing 10.

In this way, the release buttons 44 are attached to both the left and right ends of base main body 1 so as to be allowed to protrude and retracting in the Y direction (that is, width direction) in a state where main body 441 is biased outward in the Y direction (that is, width direction) by coil spring 443.

When outer blade block B2 is put on housing B1 from above while two net inner blades 512 are disposed inside corresponding net blades 511, two finishing net inner blades 522 are attached to drive pins 4326 and 4327, and one slit inner blade 532 is attached to driver 4325, hook portion 44111 of engagement hook 4411 is pushed by engagement hook 15133, and main body 441 biased outward in the Y direction (that is, width direction) moves inward in the Y direction (that is, width direction) against a biasing force of coil spring 443. At this time, engagement hook 4411 (more specifically, hook portion 44111) integrally formed with main body 441 also moves inward in the Y direction (that is, width direction) together with main body 441. Then, when outer blade block B2 is further pushed toward housing B1 in this state, engagement hook 15133 moves below hook portion 44111 of engagement hook 4411, and engagement hook 15133 and hook portion 44111 are engaged with each other. At this time, hook portion 44111 is engaged with engagement hook 15133 in a state of being biased outward in the Y direction (that is, width direction) by coil spring 443. In this way, outer blade block B2 is attached to housing B1.

In addition, in a state where outer blade block B2 is attached to housing B1, main body 441 of release button 44 is held and retracted inward from the left and right to move engagement hook 4411 (more specifically, hook portion 44111) inward in the Y direction (that is, width direction) together with main body 441. Thus, the engagement between engagement hook 15133 and hook portion 44111 is released, outer blade block B2 is allowed to be removed from housing B1.

In the present exemplary embodiment, outer blade block B2 is allowed to be removed from housing B1 in a state where two net inner blades 512 are attached to the pair of drivers 4324. In addition, two net inner blades 512 are detachably attached to the pair of drivers 4324 in a state of being biased upward. In this way, in a case where release button 44 is operated to release the engagement between engagement hook 15133 and hook portion 44111, outer blade block B2 is pushed upward by the biasing force of two net inner blades 512, and thus, outer blade block B2 can be smoothly removed from housing B1.

Note that, in a case where all the blade blocks (more specifically, all the outer blades and all the inner blades) are attached to the outer blade case, it is preferable that a flip-up mechanism is provided by interposing one or more push-up members that push up the outer blade case between the housing and the outer blade case. In this case, it is preferable that the flip-up mechanism is provided by interposing one or more sets of push-up members that push up the outer blade case upward between the housing and the outer blade case. For example, a biasing part such as a coil spring, a set of magnets that generate a magnetic repulsive force, or the like can be used as the push-up member that pushes up the outer blade case. An example of the set of magnets that generate the magnetic repulsive force is a pair of magnets disposed such that the same poles face each other. As described above, when the flip-up mechanism is provided between the housing and the outer blade case, even in a case where the outer blade block is formed by attaching all the blade blocks (more specifically, all the outer blades and all the inner blades) to the outer blade case, the outer blade block can be smoothly removed from the housing.

When the power supply of device main body B (that is, one element of electric razor A) is turned on, each inner blade is displaced relative to the corresponding outer blade (that is, is relatively moved, more specifically, reciprocates in the Y direction).

In this way, the beard (that is, an example of hair) inserted into the blade hole of each outer blade is cut by the outer blade and the inner blade by turning on the power supply of device main body B (that is, one element of electric razor A) in a state where outer blade block B2 is attached to housing B1 and bringing skin contact surface 5a of blade unit 5 into contact with skin U1 (that is, skin surface) of user U to move the blade unit while sliding in the X direction in a state where each inner blade is displaced relative to the corresponding outer blade.

Note that, when outer blade block B2 is attached to housing B1 to assemble device main body B, a space is formed inside outer blade block B2, and the beard (that is, an example of hair) cut by the outer blade and the inner blade can be stored in the space.

As described above, in the present exemplary embodiment, reciprocating-type electric razor A is used, and thus, it is possible to secure a large cutting region of the beard (that is, an example of hair) while downsizing in the front-back direction (that is, depth direction, more specifically, reciprocating direction of the inner blade) is achieved.

In addition, in the present exemplary embodiment, as described above, skin contact surface 5a of blade part E includes the surfaces (that is, outer surfaces) of the outer blades of the plurality of blade blocks, and is a surface that can be approximated by a curved surface protruding outward as a whole.

When device main body B stands by itself, a most outwardly protruding point of the curved surface that approximates skin contact surface 5a of blade part E is positioned at an uppermost portion, and a contact plane at the most outwardly protruding point of the curved surface that approximates skin contact surface 5a of blade part E is the horizontal plane.

As described above, in the present exemplary embodiment, skin contact surface 5a of blade part E is exposed upward in a state where an extending direction of base D is substantially accorded with the up-down direction while device main body B is disposed such that blade part E is positioned at the upper portion and base D is positioned at the lower portion. Accordingly, each inner blade reciprocates linearly in a horizontal direction with respect to the corresponding outer blade in a state where the extending direction of base D is substantially accorded with the up-down direction while device main body B is disposed such that blade part E is positioned at the upper portion and base D is positioned at the lower portion.

Thus, in the present exemplary embodiment, when the extending direction of base D is substantially accorded with the up-down direction while device main body B is disposed such that blade part E is positioned at the upper portion and base D is positioned at the lower portion, a drive surface of the inner blade is a surface substantially parallel to the horizontal plane.

Note that, skin contact surface 5a can be inclined with respect to the horizontal plane in a state where the extending direction of base D is substantially accorded with the up-down direction while device main body B is disposed such that blade part E is positioned at the upper portion and base D is positioned at the lower portion.

For example, it is possible to adopt a configuration in which a portion (more specifically, skin contact surface 5a) of blade part E in contact with skin U1 is inclined forward and downward with respect to the horizontal plane in a state where the extending direction of base D is substantially accorded with the up-down direction while device main body B is disposed such that blade part E is positioned at the upper portion and base D is positioned at the lower portion. In this way, skin contact surface 5a can be easily brought into contact with skin U1 of user U when device main body B (that is, one element of electric razor A) is used in a state where base D is wrapped with hand U2 from the bottom surface side.

In addition, such a configuration can be formed by directly attaching blade part E to base D (that is, an example of the main body), or can be formed by attaching blade part E to a head portion such that base D includes the head portion.

Next, a specific configuration of base main body 1 having a waterproof function will be described.

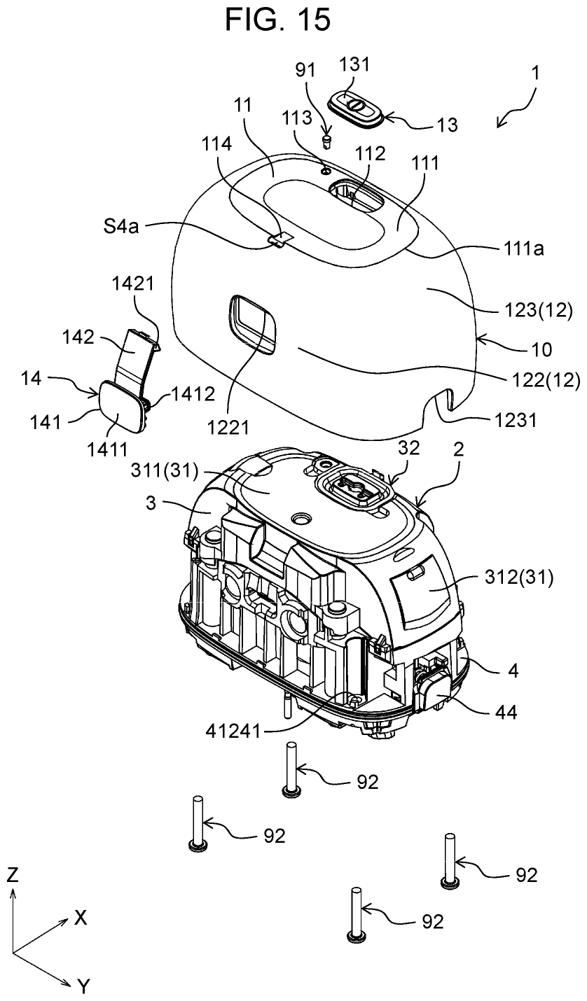

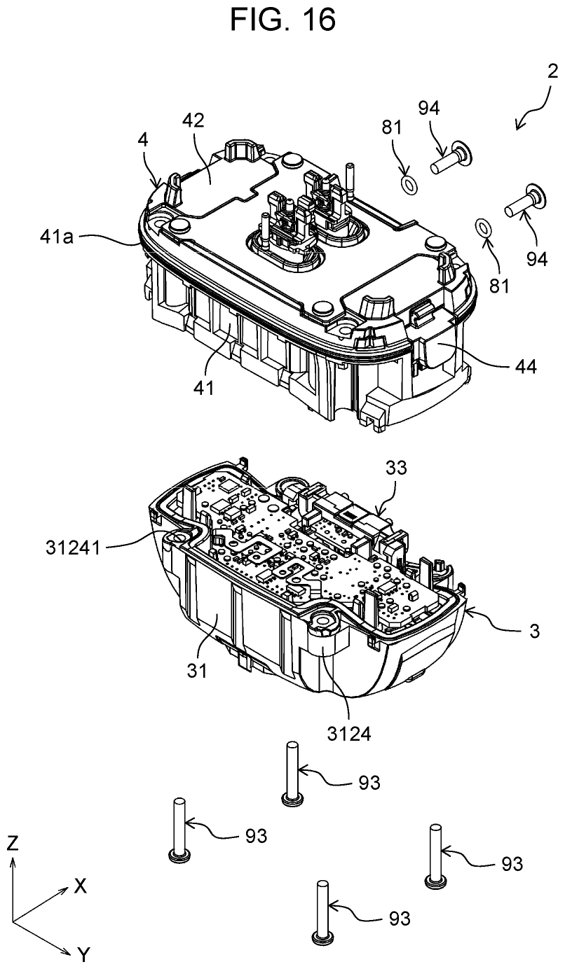

FIG. 14 is a partially exploded view illustrating base main body 1, and is a perspective view of a state where waterproof unit 2, switch button 13, and USB cap 14 are removed from lower base housing 10 as viewed from above on the front side. FIG. 15 is a partially exploded view illustrating base main body 1, and is a perspective view of a state where waterproof unit 2, switch button 13, and USB cap 14 are removed from lower base housing 10 as viewed from below on the back side. In the present exemplary embodiment, as illustrated in FIGS. 14 and 15, base main body 1 includes lower base housing 10 and waterproof unit 2 disposed within a cavity of lower base housing 10.

In the present exemplary embodiment, lower base housing 10 includes bottom wall 11 having a rectangular plate shape with rounded corners and peripheral wall 12 connected to rise upward from an outer peripheral edge of bottom wall 11, and a shape of lower base housing 10 is a rectangular bottomed hollow-columnar shape with rounded corners.

In addition, as illustrated in FIG. 15, through-hole 112 is formed at a central portion in the Y direction (that is, width direction) of a front end portion in the X direction (that is, front-back direction) of bottom wall 11, and through-hole 112 is closed by switch button 13 (that is, an example of an operator).

In the present exemplary embodiment, switch button 13 is attached to bottom wall 11 in a state of being movable in a penetrating direction (that is, a plate thickness direction of bottom wall 11) of through-hole 112. Switch button 13 is pressed, and thus, on and off of the power supply of device main body B (that is, one element of electric razor A) can be switched.

As described above, in the present exemplary embodiment, switch button 13 (that is, an example of the operator) capable of switching between on and off of the power supply is formed on bottom wall 11 of base D in a state where blade part E is positioned at the upper portion and base D is positioned at the lower portion.

In this way, it is possible to more reliably suppress an erroneous operation of switch button 13 in a state where peripheral wall D1 of base D is gripped.

Note that, in the present exemplary embodiment, although it has been described that press-type switch button 13 is the operator for switching between on and off of the power supply, other operators may be used. For example, it is also possible to use an operator such as a mechanical switch such as a slide-type operator, an electrostatic sensor, a pressure sensitive sensor, or a switch other than the mechanical switch.

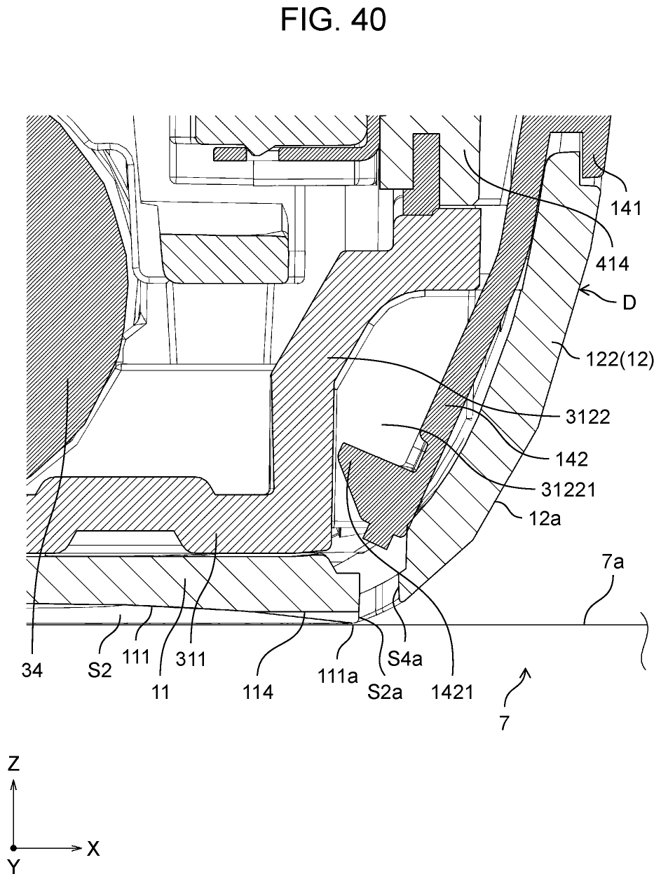

FIG. 40 is an enlarged schematic cross-sectional view illustrating the slit portion of FIG. 37. In the present exemplary embodiment, as illustrated in FIGS. 36 to 40, bottom wall 11 has a shape curved to protrude upward, and bottom surface 111 is a recessed curved surface curved to protrude upward. When device main body B (that is, one element of electric razor A) is mounted on mounting surface 7a in a state where bottom wall 11 faces downward, only peripheral edge portion 111a of bottom surface 111 comes into contact with mounting surface 7a.

In this way, as illustrated in FIGS. 36 to 40, when device main body B (that is, one element of electric razor A) is mounted on mounting surface 7a in a state where bottom wall 11 faces downward, second space S2 is formed between bottom surface 111 (that is, one element of bottom wall 11) and mounting surface 7a. Second space S2 is a space defined by bottom surface 111 and mounting surface 7a when device main body B (that is, one element of electric razor A) is mount on mounting surface 7a in a state where bottom wall 11 faces downward.

Further, in the present exemplary embodiment, when switch button 13 is attached to bottom wall 11 in a state where the switch button is not pressed inward, outer surface 131 of switch button 13 is substantially flush with bottom surface 111. In this way, a gap is formed between outer surface 131 and mounting surface 7a in a state where device main body B (that is, one element of electric razor A) is mounted on mounting surface 7a.

In this way, when device main body B (that is, one element of electric razor A) is mounted on mounting surface 7a, it is possible to more reliably suppress interference of outer surface 131 of switch button 13 (that is, an example of the operator) with mounting surface 7a. That is, when device main body B (that is, one element of electric razor A) is mounted on mounting surface 7a, it is possible to more reliably suppress the operation of switch button 13 (that is, an example of the operator) by mounting surface 7a.

As described above, in the present exemplary embodiment, it is also possible to suppress switching between on and off of the power supply in a state where device main body B (that is, one element of electric razor A) is mounted on mounting surface 7a while switching between on and off of the power supply in a state where peripheral wall D1 of base D is gripped is suppressed. That is, it is possible to more reliably suppress an unintentional operation of switch button 13 (that is, an example of the operator).

In addition, in the present exemplary embodiment, second space S2 formed between bottom surface 111 (that is, one element of bottom wall 11) and mounting surface 7a is a non-closed space. Specifically, as illustrated in FIG. 40, cutout 114 is formed in bottom wall 11 to divide peripheral edge portion 111a, and thus, second space S2 communicates with an external space by communication hole S2a defined by cutout 114 and mounting surface 7a when device main body B (that is, one element of electric razor A) is mounted on mounting surface 7a. In this way, second space S2 becomes the non-closed space. Note that, in the present exemplary embodiment, although it has been described that communication hole S2a communicates with discharge port S4a from the viewpoint of designability, the present disclosure is not limited to such a configuration. For example, communication hole S2a may be formed in only one portion that does not communicate with discharge port S4a. In addition, communication holes S2a may be formed at two or more portions. At this time, communication hole S2a communicating with discharge port S4a may be provided, or communication hole S2a communicating with discharge port S4a does not have to be provided.

As described above, when second space S2 is the non-closed space, a drying property of device main body B (that is, one element of electric razor A) can be further improved. For example, even in a case where device main body B (that is, one element of electric razor A) is mounted on mounting surface 7a in a state where a liquid such as water adheres to bottom wall 11, bottom wall 11 can be more quickly dried.

In addition, in the present exemplary embodiment, through-hole 113 (that is, press-fitting hole) is formed on one side of bottom wall 11 in the Y direction (width direction) of through-hole 112, and through-hole 113 (that is, press-fitting hole) communicates with press-fitting hole 3112 formed in bottom wall 311 of lower housing 31 of waterproof unit 2 when waterproof unit 2 is disposed within the cavity of lower base housing 10.

Then, rivet 91 (that is, an example of a press-fitting member) is press-fitted into through-hole 113 (that is, press-fitting hole) and press-fitting hole 3112 from below in a state where through-hole 113 (that is, press-fitting hole) and press-fitting hole 3112 communicate with each other while waterproof unit 2 is disposed within the cavity of lower base housing 10, and thus, waterproof unit 2 is fixed to lower base housing 10.

Further, in the present exemplary embodiment, ribs 120 in which screw holes 120a are formed are formed at four corners inside peripheral wall 12, and when waterproof unit 2 is disposed within the cavity of lower base housing 10, screw holes 120a communicate with screw holes 41241 formed in flange portion 4124 of upper housing 41 of waterproof unit 2, which will be described later, and screw holes 4211 formed in top wall main body 421 of top wall 42.

Screw 92 is inserted into screw hole 4211, screw hole 41241, and screw hole 120a from above in a state where screw hole 120a communicates with screw hole 41241 and screw hole 4211 while waterproof unit 2 is disposed within the cavity of lower base housing 10, and thus, waterproof unit 2 is fixed to lower base housing 10.

In addition, peripheral wall 12 includes front wall 121, rear wall 122, and a pair of side walls 123 coupling front wall 121 and rear wall 122.

Through-hole 1211 is formed at a central portion of a lower end of front wall 121 in the Y direction (that is, width direction). In the present exemplary embodiment, as described above, the appearance (that is, the shape of outer surface D1a) of peripheral wall D1 of base D has a smoothly curved shape such that the central portion thereof bulges as a whole. Thus, the lower end of front wall 121 is an inclined surface inclined downward and inward, and through-hole 1211 is positioned in front of a front end of bottom wall 11. Accordingly, as illustrated in FIG. 37, through-hole 1211 is allowed to face mounting surface 7a without being obstructed by bottom wall 11 in a state where device main body B (that is, one element of electric razor A) is mounted on mounting surface 7a.

In the present exemplary embodiment, as illustrated in FIG. 37, a distal end of light guide unit 323 (that is, an example of a display unit) is inserted into through-hole 1211.

As described above, in the present exemplary embodiment, light guide unit 323 (that is, an example of the display unit) is formed at a coupling portion of peripheral wall 12 of base D with bottom wall 11 in a state where blade part E is positioned at the upper portion and base D is positioned at the lower portion. Light guide unit 323 (that is, an example of the display unit) is provided to notify user U or the like of a status of device main body B. For example, user U or the like can be notified that device main body B is in an energized state, that battery 34 is being charged, and the like by color of light to be emitted and a light emission method (for example, constant lighting, blinking, and the like).

When light guide unit 323 (that is, an example of the display unit) is formed at the coupling portion of peripheral wall 12 of base D with bottom wall 11, light guide unit 323 (that is, an example of the display unit) is formed at a portion of base D that is not very noticeable. Thus, light guide unit 323 (that is, an example of the display unit) can be visually recognized while the design property of device main body B (that is, one element of electric razor A) is improved.

For example, when device main body B (that is, one element of electric razor A) is mounted on mounting surface 7a in a state where light guide unit 323 (that is, an example of the display unit) is lit, since the light emitted from light guide unit 323 (that is, an example of the display unit) is reflected by mounting surface 7a, user U or the like can confirm the status of device main body B by confirming the reflected light. In addition, in a state where light is not emitted from light guide unit 323 (that is, an example of the display unit), since light guide unit 323 (that is, an example of the display unit) becomes unnoticeable, deterioration of appearance can be suppressed when, for example, electric razor A is decorated as the interior of the room.

Further, in the present exemplary embodiment, light guide unit 323 (that is, an example of the display unit) is formed near switch button 13 (that is, an example of the operator). In this way, when switch button 13 (that is, an example of the operator) is operated, the light emitted to the outside from light guide unit 323 (that is, an example of the display unit) can be easily visually recognized. That is, an operation state (for example, an energized state or the like) of switch button 13 (that is, an example of the operator) can be more easily confirmed.

In addition, in the present exemplary embodiment, through-hole 1221 through which USB terminal 3332 (that is, an example of a charging unit), which will be described later, can be exposed to the outside is formed at a central portion of rear wall 122. In base main body 1, USB cap 14 (that is, an example of a cap) capable of openably closing through-hole 1221 is held in a state of being prevented from coming off. When through-hole 1211 is closed by USB cap 14, USB terminal 3332 (that is, an example of the charging unit) can be protected in a waterproof state by USB cap 14 (that is, an example of the cap).

Specifically, USB cap 14 includes cap main body 141 capable of openably closing through-hole 1221, and coupling piece 142 coupled to cap main body 141. Further, waterproof cover 1412 into which a distal end of USB terminal 3332 (that is, an example of the charging unit) is inserted and which can seal USB terminal 3332 (that is, an example of the charging unit) is formed inside cap main body 141.

When cap main body 141 openably closes through-hole 1221, the distal end of USB terminal 3332 (that is, an example of the charging unit) is inserted into waterproof cover 1412, and USB terminal 3332 (that is, an example of the charging unit) is sealed by waterproof cover 1412. In this way, USB cap 14 can protect USB terminal 3332 (that is, an example of the charging unit) in a waterproof state.

In addition, in the present exemplary embodiment, hook 1421 for retaining is formed at a distal end of coupling piece 142 to protrude forward, and USB cap 14 is held by base main body 1 in a state where hook 1421 is accommodated in accommodation recess 31221 formed in rear wall 3122 of lower housing 31. As illustrated in FIG. 37, in a state where waterproof unit 2 is disposed within the cavity of lower base housing 10, an opening formed above accommodation recess 31221 is narrowed by rear wall 3122 of lower housing 31 and rear wall 122 of lower base housing 10. In the present exemplary embodiment, the opening formed above accommodation recess 31221 is formed to be slightly wider than a thickness of coupling piece 142. In this way, although coupling piece 142 is allowed to be moved up and down, hook 1421 is not allowed to be moved above accommodation recess 31221, and USB cap 14 capable of openably closing through-hole 1221 is held by base main body 1 in a state of being prevented from coming off.

Further, in the present exemplary embodiment, outer surface 1411 of cap main body 141 is substantially flush with outer surface 12a of peripheral wall 12 in a state where cap main body 141 closes through-hole 1221. In this way, it is possible to suppress catching of finger U22 by cap main body 141 when device main body B (that is, one element of electric razor A) is in use, and it is possible to further improve operability when device main body B (that is, one element of electric razor A) is in use.

FIG. 33 is a diagram schematically illustrating an example of a method for charging electric razor A. When cap main body 141 is removed to open through-hole 1221, USB terminal 3332 (that is, an example of the charging unit) is exposed to the outside as illustrated in FIG. 33. Battery 34 is charged by inserting USB cable 8 (that is, an example of a charging code) into USB terminal 3332 (that is, an example of the charging unit) in a state where USB terminal 3332 (that is, an example of the charging unit) is exposed to the outside.

As described above, in the present exemplary embodiment, USB terminal 3332 (that is, an example of the charging unit) into which USB cable 8 (that is, an example of the charging code) can be inserted is formed on peripheral wall 12 of base D in a state where blade part E is positioned at the upper portion and base D is positioned at the lower portion.

In this way, battery 34 can be charged in a state where device main body B (that is, one element of electric razor A) is mounted on mounting surface 7a, and usability of device main body B (that is, one element of electric razor A) can be further improved.

In addition, in the present exemplary embodiment, upper packing 41a is attached to an upper portion (more specifically, upper housing 41) of a peripheral wall of waterproof unit 2. When waterproof unit 2 is disposed within the cavity formed inside lower base housing 10 and is fixed to lower base housing 10, upper packing 41a is brought into contact with the inner surface of peripheral wall 12 of lower base housing 10. In this way, a space formed between waterproof unit 2 and lower base housing 10 is sealed on an upper side.

However, in the present exemplary embodiment, in order to detachably attach outer blade block B2 to housing B1, a pair of release buttons 44 is attached to an upper portion of base main body 1 in a state of being allowed to protrude and retract in the Y direction (that is, width direction).

Accordingly, a gap communicating with the space formed between waterproof unit 2 and lower base housing 10 is formed in a portion of base main body 1 where release button 44 is formed. Thus, a liquid such as water, cut beard (that is, an example of cut hair), and the like may enter the space formed between waterproof unit 2 and lower base housing 10 through the gap formed in the portion of base main body 1 where release button 44 is formed.

As described above, the present exemplary embodiment has a problem that a region to be non-waterproof space S4 is formed in the space formed between waterproof unit 2 and lower base housing 10. That is, non-waterproof space S4 is formed outside main-body-side waterproof space S3 in base D.

To solve the problem, in the present exemplary embodiment, discharge port S4a through which a liquid present inside non-waterproof space S4 is allowed to be discharged to the outside is formed at the lower end of base D in a state where blade part E is positioned at the upper portion and base D is positioned at the lower portion.

Specifically, a through-hole is formed at a central portion of a lower end of rear wall 122 in the Y direction (that is, width direction), and the through-hole functions as discharge port S4a. In the present exemplary embodiment, as described above, the appearance (that is, the shape of outer surface D1a) of peripheral wall D1 of base D has a smoothly curved shape such that the central portion thereof bulges as a whole. Thus, the lower end of rear wall 122 is also an inclined surface inclined downward and inward, and is positioned behind a rear end of bottom wall 11. Accordingly, as illustrated in FIG. 37, discharge port S4a is allowed to face mounting surface 7a without being closed by bottom wall 11 in a state where device main body B (that is, one element of electric razor A) is mounted on mounting surface 7a.

In this way, non-waterproof space S4 has a function as a discharge path. A liquid such as water entering non-waterproof space S4, cut beard (that is, an example of cut hair), and the like can be more quickly discharged to the outside.

In particular, in the present exemplary embodiment, discharge port S4a is formed at the lower end of base D in a state where blade part E is positioned at the upper portion and base D is positioned at the lower portion. Thus, in the present exemplary embodiment, in a state where electric razor A or device main body B stands on mounting surface 7a, a liquid such as water entering non-waterproof space S4, cut beard (that is, an example of cut hair), and the like can be more quickly discharged to the outside.

Cutout 1231 that opens upward is formed at each upper end of the central portion of the pair of side walls 123 in the X direction, and the operation portion of main body 441 is inserted into cutout 1231.

Next, a specific configuration of waterproof unit 2 will be described.

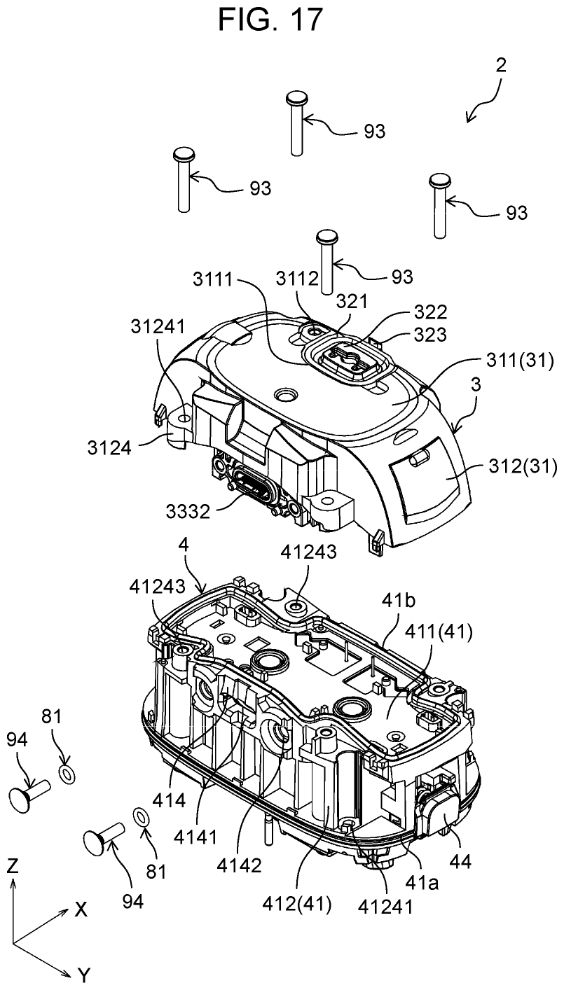

FIG. 16 is a perspective view of waterproof unit 2 disassembled into lower unit 3 and upper unit 4 as viewed from above on the front side. FIG. 17 is a perspective view of waterproof unit 2 disassembled into lower unit 3 and upper unit 4 as viewed from below on the back side. In the present exemplary embodiment, waterproof unit 2 is obtained by assembling the members such that main-body-side waterproof space S3 is formed inside, and as illustrated in FIGS. 16 and 17, waterproof unit 2 includes lower unit 3 having lower housing 31 and disposed on a lower side, and upper unit 4 having upper housing 41 and coupled to an upper portion of lower unit 3.

Note that, in the present exemplary embodiment, lower packing 41b is attached to a lower end of upper housing 41, and upper housing 41 and lower housing 31 are sealed by lower packing 41b when upper unit 4 is coupled to an upper portion of lower unit 3.

Lower unit 3 has lower housing 31 that opens upward, and lower housing 31 includes rectangular plate-shaped bottom wall 311 with rounded corners and peripheral wall 312 that is connected to rise upward from an outer peripheral edge of bottom wall 311. As described above, in the present exemplary embodiment, a shape of lower housing 31 is also a rectangular bottomed hollow-columnar shape with rounded corners.

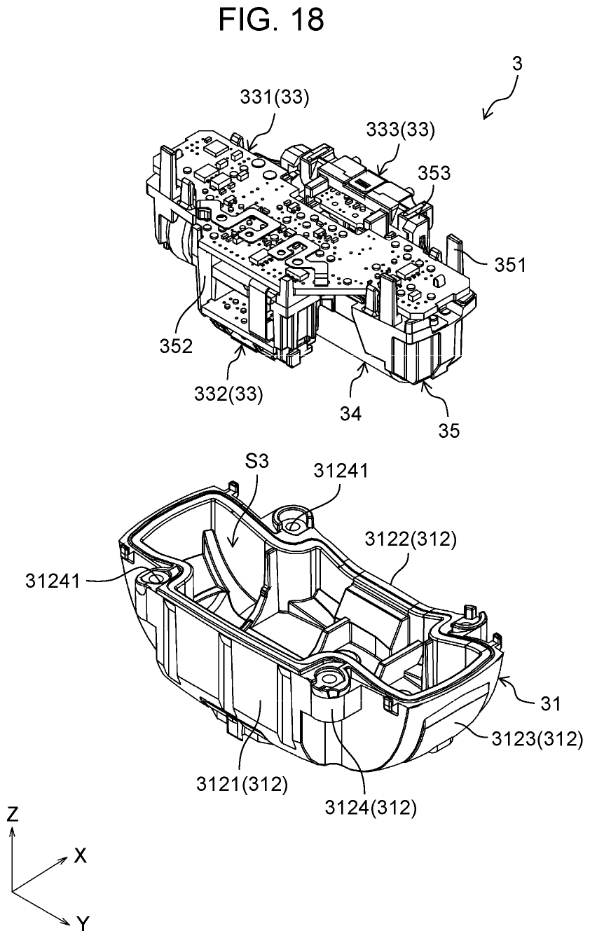

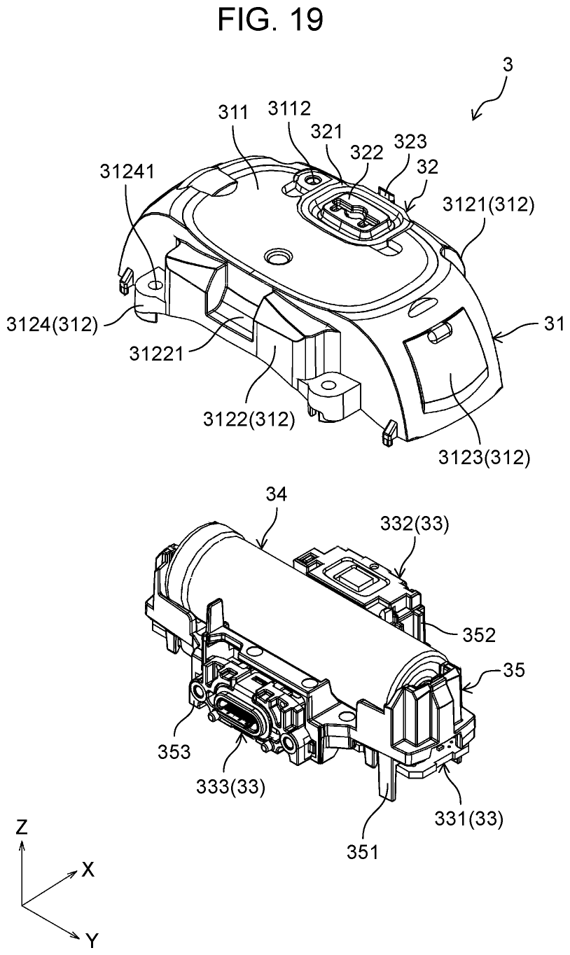

FIG. 18 is a partially exploded view of lower unit 3, and is a perspective view of a state where components are removed from lower housing 31 as viewed from above on the front side. FIG. 19 is a partially exploded view of lower unit 3, and is a perspective view of a state where the internal components are removed from lower housing 31 as viewed from below on the back side. As illustrated in FIGS. 18 and 19, a cavity is formed inside lower housing 31, and internal components such as circuit unit 33 and battery 34 are accommodated within the cavity formed inside lower housing 31.

In addition, as illustrated in FIG. 17, through-hole 3111 is formed at a central portion in the Y direction (that is, width direction) of a front end portion in the X direction (that is, in the front-back direction) of bottom wall 311, and through-hole 3111 is closed by sealing member 32. Through-hole 3111 is formed at a position corresponding to through-hole 112 closed by switch button 13, and when waterproof unit 2 is disposed within the cavity formed inside lower base housing 10 and is fixed to lower base housing 10, scaling member 32 closing through-hole 3111 faces switch button 13.

Sealing member 32 includes main body 321 that is brought into contact with through-hole 3111, and bending portion 322 that is connected inside main body 321 and is bendable in a penetrating direction (that is, a plate thickness direction of bottom wall 311) of through-hole 3111. Bending portion 322 is formed to face switch button 13 when waterproof unit 2 is disposed within the cavity formed inside lower base housing 10 and is fixed to lower base housing 10. In the present exemplary embodiment, bending portion 322 is formed to be elastically bent when switch button 13 is pressed. In this way, when hand U2 is released from switch button 13 in a state where switch button 13 is pressed, bending portion 322 moves to return to an original position, and switch button 13 also returns to an original position due to the movement of bending portion 322.

Further, sealing member 32 includes light guide unit 323 (that is, an example of the display unit), and when waterproof unit 2 is disposed within the cavity formed inside lower base housing 10 and is fixed to lower base housing 10, a distal end of light guide unit 323 (that is, an example of the display unit) is inserted into through-hole 1211 formed at the central portion of the lower end of front wall 121 in the Y direction (that is, width direction).

In addition, press-fitting hole 3112 described above is formed on one side of bottom wall 311 in the Y direction (that is, width direction) of through-hole 3111, and press-fitting hole 3112 communicates with through-hole 113 (that is, press-fitting hole) formed in bottom wall 11 of lower base housing 10 when waterproof unit 2 is disposed within the cavity of lower base housing 10.

In addition, in the present exemplary embodiment, extension walls 3124 are formed outside four corners of peripheral wall 312, and screw holes 31241 are formed in extension walls 3124. Screw hole 31241 communicates with lower screw holes 41243 formed in flange portion 4124 of upper housing 41.

Then, screw 93 is inserted into screw holes 31241 and lower screw holes 41243 from below in a state where screw holes 31241 communicate with lower screw holes 41243, and thus, upper housing 41 is fixed to lower housing 31.

In addition, peripheral wall 312 includes front wall 3121, rear wall 3122, and a pair of side walls 3123 coupling front wall 3121 and rear wall 3122.

Accommodation recess 31221 is formed at a central portion of a lower end of rear wall 3122 in the Y direction (that is, width direction), and hook 1421 which is provided for retaining and formed at a distal end of coupling piece 142 of cap main body 141 is accommodated in accommodation recess 31221. In the present exemplary embodiment, hook 1421 is accommodated in accommodation recess 31221 in a state where the distal end (more specifically, hook 1421) of coupling piece 142 is inserted into through-hole 1221 from the outside (that is, rear side) such that cap main body 141 is positioned outside lower base housing 10.

As illustrated in FIGS. 18 and 19, circuit unit 33, battery 34, and battery holding table 35 as internal components are accommodated within the cavity formed inside lower housing 31.

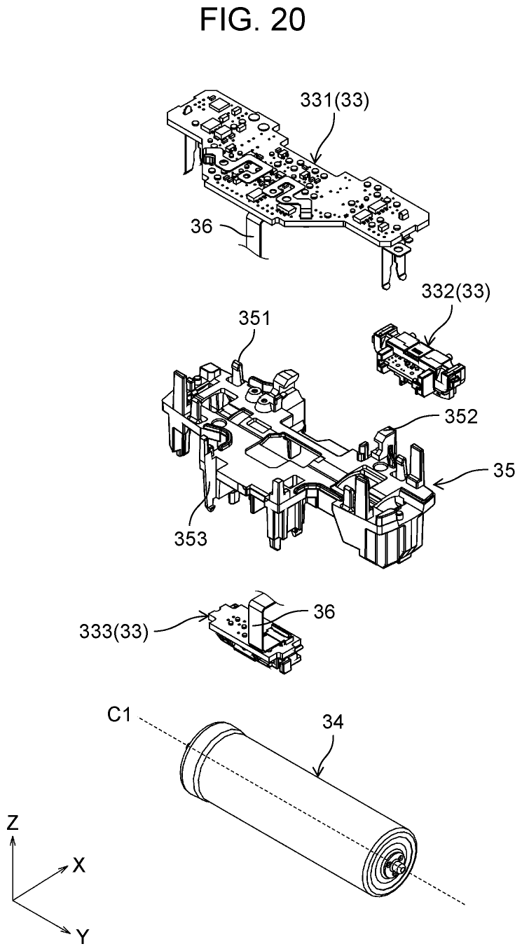

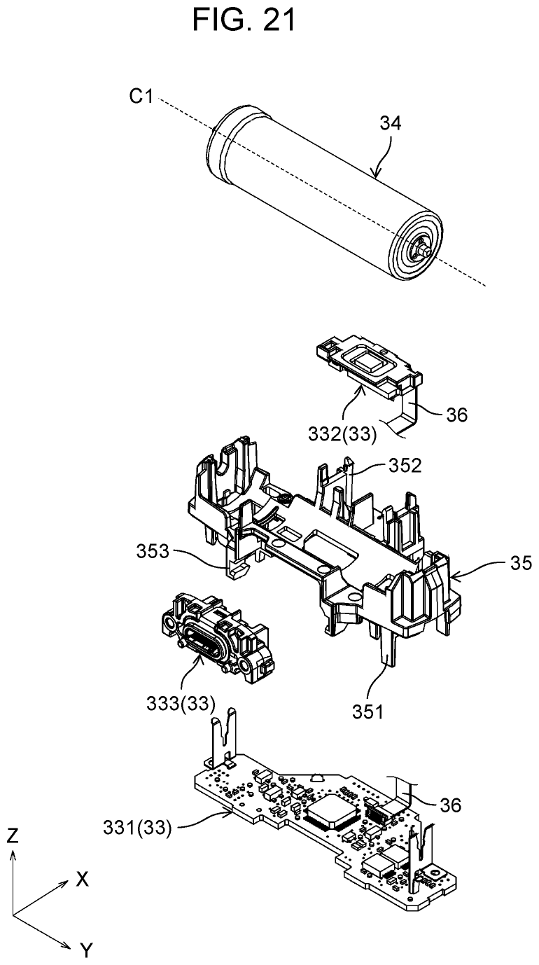

FIG. 20 is an exploded perspective view of the internal components of lower unit 3 as viewed from above on the front side. FIG. 21 is an exploded perspective view of the internal components of lower unit 3 as viewed from below on the back side. In the present exemplary embodiment, as illustrated in FIGS. 20 and 21, circuit unit 33 includes main circuit unit 331 for driving linear motor 43 (that is, an example of the motor), which will be described later, sub-circuit unit 332 for controlling on and off of a power supply, and USB circuit unit 333 for charging battery 34. As described above, in the present exemplary embodiment, circuit unit 33 for controlling device main body B (that is, one element of electric razor A) is divided into three circuit units. Three circuit units are disposed in a gap formed around battery holding table 35 disposed at a center of the cavity formed inside lower housing 31. In this way, the height dimension of device main body B (that is, one element of electric razor A) is allowed to be reduced by effectively utilizing the cavity formed inside lower housing 31.

In the present exemplary embodiment, battery holding table 35 is disposed at the center of the cavity formed inside lower housing 31 in a state where a space for holding battery 34 faces downward while the longitudinal direction thereof is substantially accorded with the Y direction (that is, width direction).

As described above, in the present exemplary embodiment, the space for holding battery 34 formed in battery holding table 35 is first space S1 in which battery 34 capable of supplying electric power to linear motor 43 (that is, an example of the motor) is disposed, and first space S1 has an elongated shape in the Y direction (that is, the width direction and the first direction) extending in the horizontal direction in a state where blade part E and base D are lined up in the up-down direction.

In this way, first space S1 formed in base D is formed to be horizontally long (that is, a space elongated in the width direction), spreading of base D in the Z direction (that is, a vertical direction and the up-down direction) is allowed to be suppressed, and a dimension of device main body B (that is, one element of electric razor A) in the height direction (that is, the vertical direction and the up-down direction) is allowed to be further reduced.

At this time, first space S1 is formed at a central portion of base D in the front-rear direction (that is, second direction).

As described above, when first space S1 is formed at the central portion of base D in the front-rear direction (that is, second direction), it is possible to suppress biasing of the center of gravity of device main body B to one side in the front-rear direction (that is, second direction), and it is possible to further improve the operability when device main body B (that is, one element of electric razor A) is in use.

Note that, in the present exemplary embodiment, when the extending direction of base D is substantially accorded with the up-down direction while device main body B is disposed such that blade part E is positioned at the upper portion and base D is positioned at the lower portion, the drive surface of the inner blade is the surface substantially parallel to the horizontal plane. Thus, first space S1 also has an elongated shape in a direction substantially parallel to the drive surface of the inner blade.

In addition, as battery 34 disposed in first space S1, for example, a dry battery and a rechargeable battery having the same shape as the dry battery and being compatible with the dry battery. In the present exemplary embodiment, only one rechargeable battery having the same shape as the dry battery and being compatible with the dry battery is used. An example of the rechargeable battery being compatible with the dry battery is a rechargeable battery having a dry battery shape.

The rechargeable battery (that is, an example of battery 34) having the dry battery shape is disposed in first space S1 formed in battery holding table 35. In this way, battery 34 is disposed in first space S1 in a state where central axis C1 extends in parallel with the width direction (that is, first direction).

In addition, in the present exemplary embodiment, battery 34 is built in base D.

In this way, in a case where device main body B (that is, one element of electric razor A) has a waterproof function, device main body B is allowed to be disposed in a state where battery 34 is not allowed to be taken out from main-body-side waterproof space S3. In this way, it is possible to more reliably suppress deterioration in waterproof performance of device main body B (that is, one element of electric razor A).

Note that, base D may be configured such that battery 34 is allowed to be taken in and out from first space S1.

In this way, it is possible to more easily replace battery 34 that has become unusable due to a lifespan or the like with new battery 34.

Such a configuration can be provided, for example, by a configuration in which a through-hole communicating with first space S1 is formed in base D and the through-hole is openably closed with a lid capable of sealing main-body-side waterproof space S3.

In addition, in the present exemplary embodiment, main circuit unit 331 for driving linear motor 43 (that is, an example of the motor) is disposed near linear motor 43 (that is, an example of the motor). In addition, sub-circuit unit 332 that controls on and off of a power supply is disposed near switch button 13. USB circuit unit 333 for charging battery 34 is disposed near through-hole 1221 through which USB terminal 3332 (that is, an example of the charging unit) can be exposed.

Specifically, main circuit unit 331 is held by main circuit unit holding portion 351 formed on an upper portion of battery holding table 35, and thus, main circuit unit 331 is disposed near linear motor 43 (that is, an example of the motor). In addition, sub-circuit unit 332 is held by sub-circuit unit holding portion 352 formed on a front lower side of battery holding table 35, and thus, sub-circuit unit 332 is disposed near switch button 13. USB circuit unit 333 is held by USB circuit unit holding portion 353 formed behind battery holding table 35, and thus, USB circuit unit 333 is disposed near through-hole 1221. In this way, a circuit board included in each circuit unit is made as small as possible.

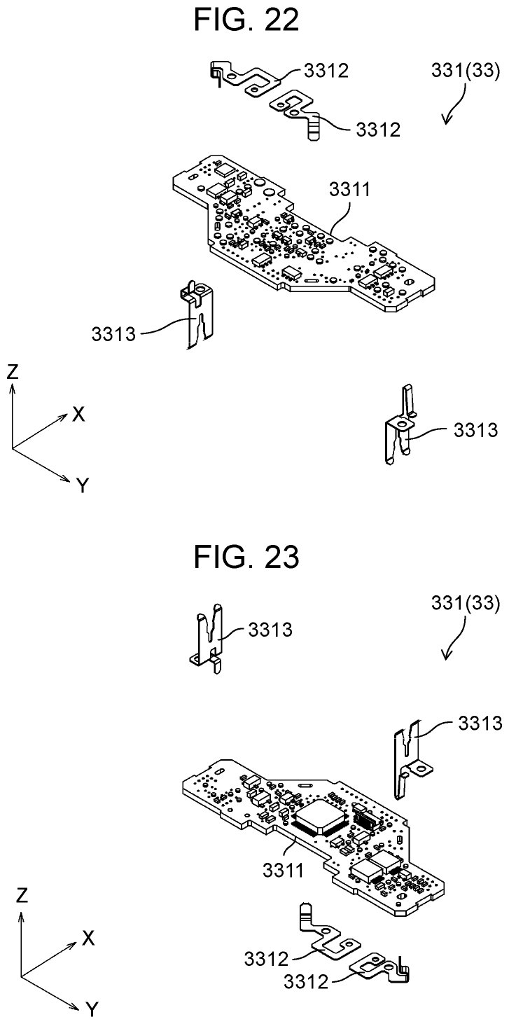

FIG. 22 is an exploded perspective view of main circuit unit 331 of lower unit 3 as viewed from above on the front side. FIG. 23 is an exploded perspective view of main circuit unit 331 of lower unit 3 as viewed from below on the back side. In the present exemplary embodiment, as illustrated in FIGS. 22 and 23, main circuit unit 331 includes main circuit board 3311, a pair of bus bar terminals 3312 electrically connected to main circuit board 3311 and electrically connected to a pair of end portions of coil 43123 of linear motor 43 (that is, an example of the motor), and a pair of electrode terminals 3313 electrically connected to main circuit board 3311 in a state of being held at both ends of battery holding table 35 in the Y direction (that is, width direction).

When the rechargeable battery (that is, an example of battery 34) having the dry battery shape is disposed in first space S1 formed in battery holding table 35, one electrode of battery 34 is electrically connected to main circuit board 3311 via one electrode terminal 3313, and other electrode of battery 34 is electrically connected to main circuit board 3311 via another electrode terminal 3313. In this way, the driving of linear motor 43 (that is, an example of the motor) is controlled by using the electric power supplied from battery 34.

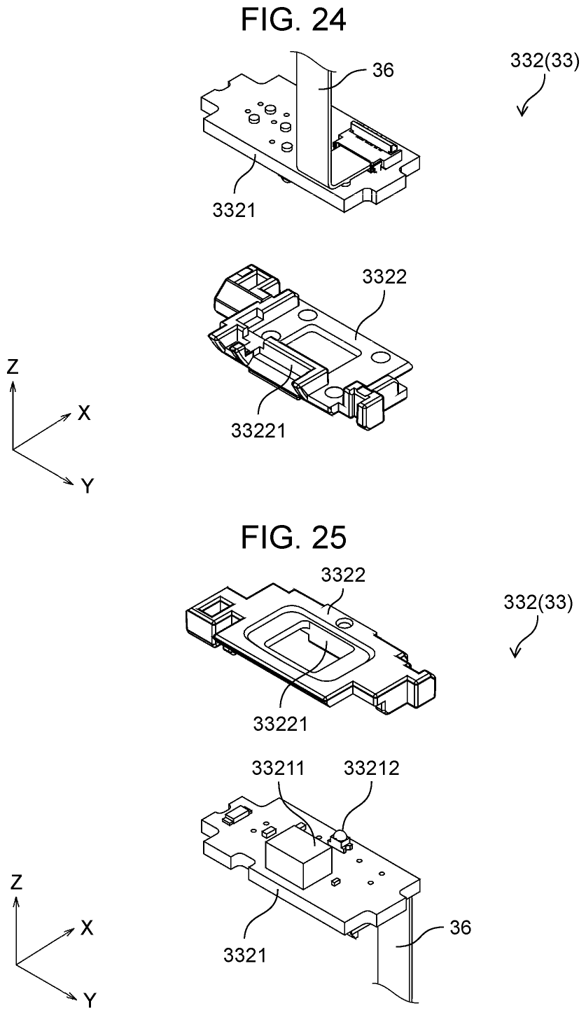

FIG. 24 is an exploded perspective view of sub-circuit unit 332 of lower unit 3 as viewed from above on the front side. FIG. 25 is an exploded perspective view of sub-circuit unit 332 of lower unit 3 as viewed from below on the back side. As illustrated in FIGS. 24 and 25, sub-circuit unit 332 includes sub-circuit board 3321 and light shielding member 3322 that is held by sub-circuit board 3321 and can suppress leakage of light emitted from LED 33212. Switch element 33211 that can be operated by switch button 13 to switch between on and off of a power supply and LED 33212 that can emit light to be emitted to the outside through light guide unit 323 (that is, an example of the display unit) are implemented on sub-circuit board 3321.

Further, in the present exemplary embodiment, light shielding plate 33221 is provided in light shielding member 3322, and the leakage of the light emitted from LED 33212 can be suppressed by light shielding plate 33221. As described above, when the leakage of the light emitted from LED 33212 can be suppressed, the light emitted from LED 33212 can be more efficiently introduced into light guide unit 323 (that is, an example of the display unit).

Note that, in the present exemplary embodiment, main circuit board 3311 and sub-circuit board 3321 are electrically connected by flexible flat cable connector 36. In this way, the driving of linear motor 43 (that is, an example of the motor) can be controlled based on a signal output from switch element 33211.

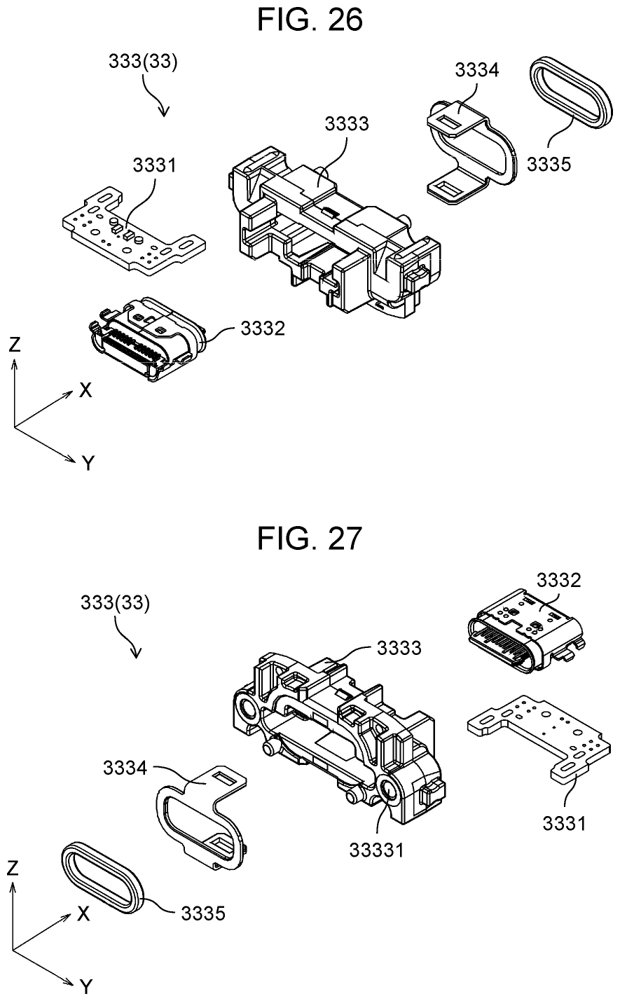

FIG. 26 is an exploded perspective view of USB circuit unit 333 of lower unit 3 as viewed from above on the front side. FIG. 27 is an exploded perspective view of USB circuit unit 333 of lower unit 3 as viewed from below on the back side. As illustrated in FIGS. 26 and 27, USB circuit unit 333 includes USB circuit board 3331, USB terminal 3332 (that is, an example of the charging unit) electrically connected to USB circuit board 3331, and holding member 3333 that holds USB terminal 3332 in a state where USB terminal 3332 is implemented on USB circuit board 3331.

Further, in the present exemplary embodiment, when waterproof unit 2 is assembled, USB terminal 3332 (that is, an example of the charging unit) can be exposed to the outside of waterproof unit 2 in a state where main-body-side waterproof space S3 is sealed.

Specifically, USB circuit unit 333 includes sealing rubber 3335 capable of scaling a periphery of USB terminal 3332 (that is, an example of the charging unit), and rubber receiving member 3334 that is attached to holding member 3333 and receives scaling rubber 3335.

A distal end of USB terminal 3332 (that is, an example of the charging unit) is inserted into through-hole 4141 formed in extension wall 414 connected to extend downward from a lower end of rear wall 4122 of upper housing 41. At this time, a space between an inner surface of extension wall 414 and an outer surface of USB terminal 3332 (that is, an example of the charging unit) is sealed by sealing rubber 3335.

In addition, as illustrated in FIGS. 17 and 27, screw holes 33331 are formed on both sides of holding member 3333 in the Y direction (that is, width direction) of USB terminal 3332 (that is, an example of the charging unit), and a pair of screw holes 33331 communicates with a pair of screw holes 4142 formed in extension wall 414 in a state where a distal end of USB terminal 3332 (that is, an example of the charging unit) is inserted into through-hole 4141. Then, holding member 3333 holding USB circuit board 3331 and USB terminal 3332 is fixed to extension wall 414 by inserting screw 94 into screw hole 4142 and screw hole 4142 from the rear in a state where screw hole 33331 communicates with corresponding screw hole 33331. At this time, screw 94 in a state where O-ring 81 is inserted into a shaft portion is inserted into screw hole 4142 and screw hole 33331. In this way, screw hole 4142 is sealed by O-ring 81.

FIG. 28 is an exploded perspective view of upper unit 4 as viewed from above on the front side. FIG. 29 is an exploded perspective view of upper unit 4 as viewed from below on the back side. As illustrated in FIGS. 28 and 29, upper unit 4 includes upper housing 41 that opens upward, and upper housing 41 includes rectangular plate-shaped bottom wall 411 with rounded corners and peripheral wall 412 connected to rise upward from an outer peripheral edge of bottom wall 411. As described above, in the present exemplary embodiment, upper housing 41 also has a rectangular bottomed hollow-columnar shape with rounded corners.

In addition, upper unit 4 has top wall 42 attached to upper housing 41 in a state of closing an upper opening of upper housing 41.

A cavity defined by upper housing 41 and top wall 42 is formed in upper unit 4, and linear motor 43 (that is, an example of the motor) is accommodated within the cavity in a state where drivers 4324 and 4325 and drive pins 4326 and 4327 are exposed upward.

As described above, in the present exemplary embodiment, the linear motor is used as a motor that drives the inner blade (more specifically, blade part E) to reciprocate. In this way, the motion of linear motor 43 (for example, reciprocating linear motion) can directly be transmitted to inner blades (more specifically, net inner blade 512, finishing net inner blade 522, and slit inner blade 532). That is, it is not necessary to separately provide a conversion mechanism. In this way, it is possible to suppress an increase in manufacturing cost while an increase in size of the device is suppressed.

Next, a specific configuration of linear motor 43 will be described.

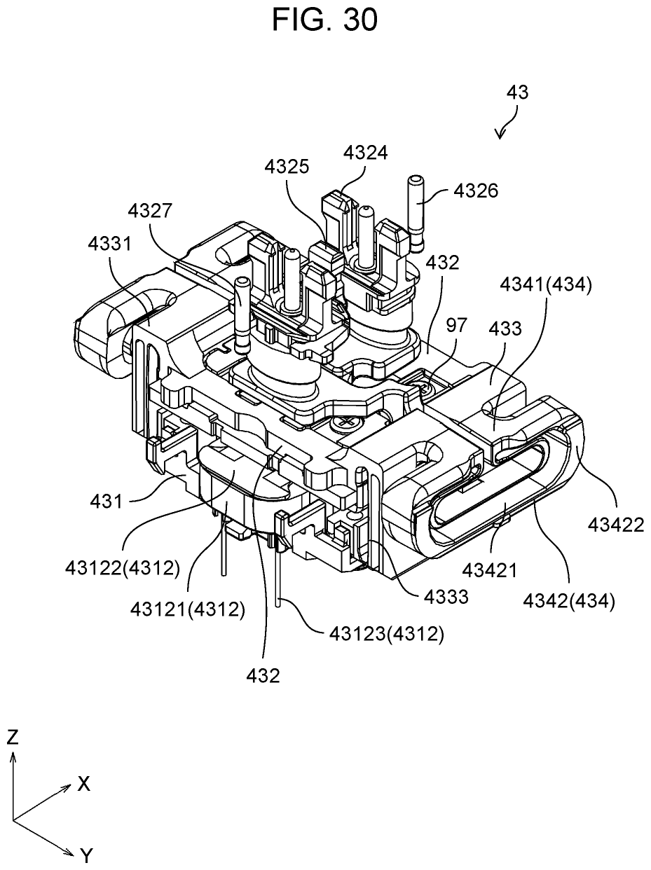

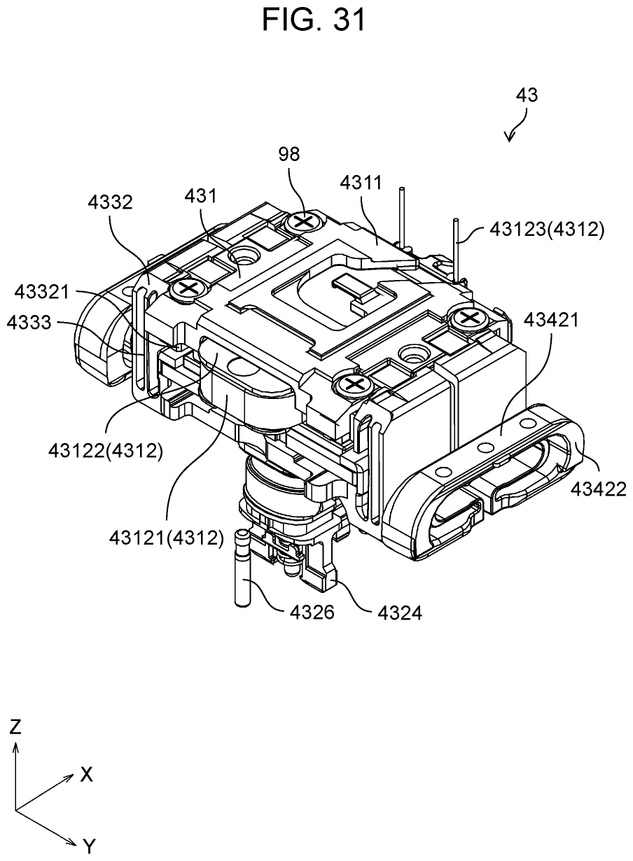

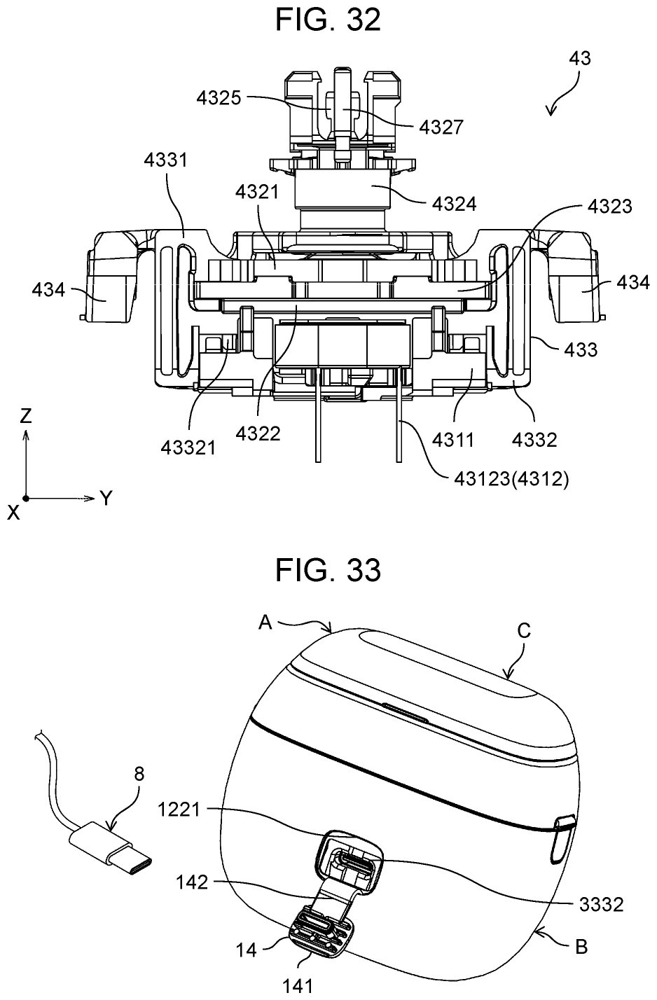

FIG. 30 is an exploded perspective view of linear motor 43 of upper unit 4 as viewed from above on the front side. FIG. 31 is an exploded perspective view of linear motor 43 of upper unit 4 as viewed from below on the back side. FIG. 32 is a side view illustrating linear motor 43 of upper unit 4. As illustrated in FIGS. 30 to 32, linear motor 43 includes electromagnetic core block 431 having electromagnet 4312, two magnetic blocks 432 having permanent magnet 4322 disposed to face electromagnet 4312, coupling plate 433 coupling each magnetic block 432 to electromagnetic core block 431, and a pair of coupling springs 434 coupling two magnetic blocks 432. In FIG. 32, the plurality of magnetic blocks 432 include two magnetic blocks 432.

Electromagnetic core block 431 includes base 4311 made of synthetic resin, and electromagnet 4312 is fixed on base 4311.

In addition, electromagnet 4312 includes core 43121 that is a magnetic body and coil 43123 wound around core 43121 via insulating bobbin 43122. Currents (more specifically, alternating current) alternately supplied in different directions are energized to coil 43123. Note that, electromagnet 4312 is disposed on base 4311 in a state where each magnetic pole surface of electromagnet 4312 faces permanent magnets 4322 of two magnetic blocks 432.

The pair of magnetic blocks 432 are disposed to be lined up in the front-back direction via a gap interposed therebetween, and each magnetic block 432 includes holding portion 4321 made of a synthetic resin, permanent magnet 4322, and back yoke 4323 made of a magnetic material. Driver 4324 is fixed to an upper surface of each holding portion 4321 with screw 97. Note that, for example, a neodymium magnet can be used as permanent magnet 4322.

Here, each magnetic block 432 is disposed to be allowed to reciprocate independently in a reciprocating direction (that is, the Y direction and the left-right direction) along with deformation of the pair of coupling plates 433. Specifically, permanent magnet 4322 of each magnetic block 432 is disposed to face the magnetic pole surface of electromagnet 4312 of electromagnetic core block 431 via a predetermined gap by each coupling plate 433. Further, permanent magnets 4322 of the pair of magnetic blocks 432 are disposed with polarities facing each other with respect to the magnetic pole surface of electromagnet 4312, and are disposed to receive electromagnetic forces (that is, attraction force and repulsive force) of opposite patterns. In this way, when electromagnet 4312 is energized, moving forces in opposite directions to each other with respect to the reciprocating direction (that is, the Y direction and the left-right direction) act on the pair of magnetic blocks 432. Note that, back yoke 4323 is disposed on an upper surface of permanent magnet 4322. That is, back yoke 4323 is disposed on a surface of permanent magnet 4322 on a side opposite to electromagnet 4312.

In addition, in the present exemplary embodiment, the pair of coupling plates 433 is integrally formed with holding portion 4321, and each coupling plate 433 includes upper extension portion 4331, lower extension portion 4332, and elastic plate portion 4333 disposed therebetween. The pair of upper extension portions 4331 is fixed to both ends of holding portion 4321. Further, attachment projection 43321 is provided in each lower extension portions 4332, and each attachment projection 43321 is fixed to base 4311 of electromagnetic core block 431 by screw 98. In this way, each magnetic block 432 is supported in a suspended state by coupling plate 433.

In addition, in the present exemplary embodiment, the pair of coupling springs 434 is formed integrally with coupling plate 433 formed integrally with holding portion 4321. That is, in the present exemplary embodiment, the pair of left and right coupling springs 434 are coupled to each magnetic block 432 via coupling plates 433 (that is, an example of an elastic support portion) formed on left and right sides of magnetic blocks 432 in the reciprocating direction (that is, the Y direction and the left-right direction).

Each coupling spring 434 includes two coupling bases 4341 (that is, an example of a root portion) and spring piece 4342 provided between coupling bases 4341. Two coupling bases 4341 of coupling springs 434 are fixed to upper extension portion 4331 of coupling plate 433 of magnetic block 432 on a front side and upper extension portion 4331 of coupling plate 433 of magnetic block 432 on a rear side.

In the present exemplary embodiment, two coupling bases 4341 of coupling springs 434 are provided to protrude outward in the reciprocating direction (that is, the Y direction and the left-right direction) from outer sides of upper extension portion 4331 in the reciprocating direction (that is, the Y direction and the left-right direction).

In addition, spring piece 4342 has a shape in which a band-shaped member is curved in a substantially C-shape, and both ends of band-shaped spring piece 4342 are connected to two coupling bases 4341. In the present exemplary embodiment, spring piece 4342 has a curved shape to have a substantially C-shape that opens upward in the Z direction (that is, up-down direction).

Further, in the present exemplary embodiment, spring piece 4342 includes substantially plate-shaped torsion portion 43421 positioned at a lower portion and extending substantially parallel to the X direction (that is, front-back direction), and bending portion 43422 extending in a substantially semicircular arc shape curved upward from both front and rear end portions of torsion portion 43421.

When the currents alternately supplied in different directions are energized to electromagnet 4312 by using linear motor 43, a moving force to one side and a moving force to the other side in the reciprocating direction (that is, the Y direction and the left-right direction) alternately act on the pair of magnetic blocks 432 by an electromagnetic force of electromagnet 4312 and permanent magnet 4322. As described above, when the moving force in the reciprocating direction (that is, the Y direction and the left-right direction) acts on each magnetic block 432, coupling plate 433 is deformed, and the pair of magnetic blocks 432 reciprocates in the reciprocating direction (that is, the Y direction and the left-right direction) along with the deformation of coupling plate 433.

Note that, in the present exemplary embodiment, the moving force in the reciprocating direction (that is, the Y direction and the left-right direction) acting on one magnetic block 432 and the moving force in the reciprocating direction (that is, the Y direction and the left-right direction) acting on the other magnetic block 432 are opposite to each other. That is, when the moving force to one side in the reciprocating direction (that is, the Y direction and the left-right direction) acts on one magnetic block 432, the moving force to the other side in the reciprocating direction (that is, the Y direction and the left-right direction) acts on other magnetic block 432. Thus, in the present exemplary embodiment, the pair of magnetic blocks 432 reciprocates in the reciprocating direction (that is, the Y direction and the left-right direction) at phases different by 180 degrees.

When the pair of magnetic blocks 432 reciprocates in the reciprocating direction (that is, the Y direction and the left-right direction), spring piece 4342 of coupling spring 434 is elastically deformed. Specifically, the pair of front and rear bending portions 43422 of spring piece 4342 is bent and deformed in opposite phases in the reciprocating direction (that is, the Y direction and the left-right direction), and torsion portion 43421 is torsionally deformed in opposite directions on a front side and a rear side about a central axis extending in the X direction (that is, front-back direction) along with the bending deformation of bending portion 43422.

As described above, when the pair of magnetic blocks 432 reciprocates in the reciprocating direction (that is, the Y direction and the left-right direction), a front portion and a rear portion of coupling spring 434 are elastically deformed in opposite directions about a center line between the pair of magnetic blocks 432. Then, a spring force due to front elastic deformation acts on magnetic block 432 on the front side, and a spring force due to rear elastic deformation acts on magnetic block 432 on the rear side. At this time, the spring force generated by the clastic deformation (more specifically, bending deformation and torsional deformation) of spring piece 4342 acts in a direction in which an amplitude of each of the pair of magnetic blocks 432 is regulated. Note that, the amplitude (more specifically, the resonance frequency) of the pair of magnetic blocks 432 can be set to be a desired value by setting a spring constant of coupling spring 434 to be a predetermined value.

A pair of screw holes 4111 is formed at a central portion in the Y direction (that is, width direction) at a central portion of bottom wall 411 in the X direction (that is, front-back direction), and linear motor 43 is fixed to upper housing 41 by inserting screws 95 into screw holes 4111 from below.

In addition, a pair of through-holes 4113 is formed at the central portion in the Y direction (that is, width direction) at a front end portion of bottom wall 411 in the X direction (that is, front-back direction), and an end portion of coil 43123 of linear motor 43 is inserted into each through-hole 4113 from above. The end portion of coil 43123 inserted into through-hole 4113 is electrically connected to bus bar terminal 3312. In this way, linear motor 43 is electrically connected to main circuit board 3311.

Here, in the present exemplary embodiment, as illustrated in FIGS. 36 and 38, linear motor 43 (that is, an example of the motor) is built in base D (that is, an example of the main body) in a state of being elongated in a direction extending in the horizontal direction. That is, linear motor 43 (that is, an example of the motor) is built in base D (that is, an example of the main body) in a horizontally long state (that is, a state of being elongated in the width direction). In this way, the spreading of base D (that is, an example of the main body) in the longitudinal direction (that is, up-down direction) can be suppressed, and the dimension of electric razor A (that is, an example of the depilatory device) in the height direction (that is, the vertical direction and the up-down direction) can be reduced.

Further, in the present exemplary embodiment, similarly to first space S1, linear motor 43 (that is, an example of the motor) also has an elongated shape in the Y direction (that is, the width direction and the first direction) extending in the horizontal direction in a state where blade part E and base D are lined up in the up-down direction. That is, linear motor 43 (that is, an example of the motor) is built in base D (that is, an example of the main body) in a state of being elongated in the width direction (that is, first direction).

In this way, the thickness of electric razor A (that is, an example of the depilatory device) can be reduced (that is, the length in the front-back direction is shortened) while the downsizing of electric razor A (that is, an example of the depilatory device) in the height direction (that is, the vertical direction and the up-down direction) is achieved.

Note that, when linear motor 43 (that is, an example of the motor) is built in base D (that is, an example of the main body), it is preferable that at least a motor main body (more specifically, a portion excluding the driver, the drive pin, and a stretched portion of the coil) is in a horizontally long state (that is, a state of being elongated in the width direction).

In the present exemplary embodiment, in linear motor 43 (that is, an example of the motor) including the driver and the drive pin, that is, a portion of linear motor 43 (that is, an example of the motor) excluding the coil stretched from a coil bobbin is in a horizontally long state (that is, a state of being elongated in the width direction) when the linear motor is built in base D (that is, an example of the main body).

As described above, in the present exemplary embodiment, linear motor 43 (that is, an example of the motor) is horizontally long (that is, a shape elongated in the width direction) in a state of including the driver and the drive pin. In this way, the downsizing of electric razor A (that is, an example of the depilatory device) in the height direction (that is, the vertical direction and the up-down direction) can be more reliably achieved. Thus, in a case where linear motor 43 (that is, an example of the motor) is built in base D (that is, an example of the main body) in the horizontally long state (that is, in a state of being elongated in the width direction), it is more preferable that linear motor 43 (that is, an example of the motor) including the driver and the drive pin is in the horizontally long state (that is, a state of being elongated in the width direction).

Further, in the present exemplary embodiment, as illustrated in FIG. 32, entire linear motor 43 (that is, an example of the motor) including the driver, the drive pin, and the stretched portion of the coil is built in base D (that is, an example of the main body) in the horizontally long state (that is, a state of being elongated in the width direction). In this way, the downsizing of electric razor A (that is, an example of the depilatory device) in the height direction (that is, the vertical direction and the up-down direction) can be further achieved. As described above, in a case where linear motor 43 (that is, an example of the motor) is horizontally long (that is, a shape elongated in the width direction), entire linear motor 43 (that is, an example of the motor) including the driver, the drive pin, and the stretched portion of the coil can be horizontally long (that is, a shape elongated in the width direction).

In addition, peripheral wall 412 includes front wall 4121, rear wall 4122, and a pair of side walls 4123 coupling front wall 4121 and rear wall 4122.

As illustrated in FIG. 17, extension wall 414 is connected at the lower end of rear wall 4122 to extend downward, and the distal end of USB terminal 3332 (that is, an example of the charging unit) is inserted into through-hole 4141 formed in extension wall 414.

In addition, as illustrated in FIGS. 28 and 29, spring receiving portion 41232 capable of bringing the distal end of coil spring 443 and detachment button holding portion 41231 capable of holding main body 441 to be allowed to protrude and retract in a state of being biased in the Y direction (that is, front-back direction) are formed at the upper portion in the Z direction at the central portions of the pair of side walls 4123 in the X direction (that is, width direction).

In addition, in the present exemplary embodiment, flange portion 4124 extending outward is formed on peripheral wall 412, and screw holes 41241 are formed at four corners of flange portion 4124. When waterproof unit 2 is disposed within the cavity of lower base housing 10, screw holes 41241 communicate with screw holes 120a formed at four corners inside peripheral wall 12 and screw holes 4211 formed in top wall main body 421 of top wall 42.

Further, upper screw holes 41242 that opens upward are formed at four corners of flange portion 4124, and upper screw holes 41242 communicate with screw holes 4212 formed in top wall main body 421 of top wall 42 and screw holes 4221 formed in pressing plate 422.

In a state where upper screw hole 41242 communicates with screw hole 4212 and screw hole 4221, screw 96 is inserted into screw hole 4221, screw hole 4212, and upper screw hole 41242 from above, and thus, top wall main body 421 and pressing plate 422 are fixed to upper housing 41.

In addition, lower screw holes 41243 that opens downward are formed at four corners of flange portion 4124, and lower screw holes 41243 communicate with screw holes 31241 formed in extension wall 3124.

In addition, in the present exemplary embodiment, top wall 42 includes top wall main body 421 attached to upper housing 41 in a state of closing the upper opening of upper housing 41, waterproof rubber 423 for sealing the cavity of upper unit 4, and pressing plate 422 for pressing waterproof rubber 423.

In the present exemplary embodiment, waterproof rubber 423 is pinched between top wall main body 421 and pressing plate 422, waterproof rubber 423 is pressed by pressing plate 422.

In addition, screw hole 4211 for fixing lower base housing 10 and top wall main body 421 with upper housing 41 interposed therebetween is formed in top wall main body 421. Screw hole 4212 for fixing top wall main body 421 and pressing plate 422 to upper housing 41 is formed in top wall main body 421. Further, a pair of insertion holes 4213 are formed in top wall main body 421. By inserting the pair of drivers 4324 into the pair of insertion holes 4213 respectively from below, the pair of drivers 4324 are exposed upward.

In addition, screw holes 4221 for fixing top wall main body 421 and pressing plate 422 to upper housing 41 are formed in pressing plate 422. Further, a pair of insertion holes 4222 are formed in pressing plate 422. By inserting the pair of drivers 4324 into the pair of insertion holes 4222 respectively from below, the pair of drivers 4324 are exposed upward.

In addition, a pair of through-holes 4231 are formed in waterproof rubber 423. By inserting the pair of drivers 4324 into the pair of through-holes 4231 respectively from below, waterproof rubber 423 is brought into close contact with a side portion of driver 4324. Thus, the cavity defined by upper housing 41 and top wall 42 is sealed.

As described above, in the present exemplary embodiment, the cavity formed inside lower base housing 10 and the cavity defined by upper housing 41 and top wall 42 are main-body-side waterproof spaces S3 formed inside waterproof unit 2.

Next, a specific configuration of protective cap C will be described.

Protective cap C is a member for protecting skin contact surface 5a of blade part E exposed to the outside of device main body B when the device is not in use, and can be detachably attached to device main body B.

In the present exemplary embodiment, protective cap C is detachably attached to device main body B by using the magnetic force, and unevenness (more specifically, mechanical fixed shape) capable of being engaged with protective cap C is not formed in base D.

As described above, when the unevenness (more specifically, mechanical fixed shape) is not provided in base D, unlike the case where the unevenness (more specifically, mechanical fixed shape) is provided in base D, since it is possible to suppress catching of finger U22 on the unevenness when device main body B (that is, one element of electric razor A) is used, it is possible to further improve the operability when device main body B (that is, one element of electric razor A) is in use.

Specifically, magnet 63 such as a neodymium magnet is attached to protective cap C. Five outer blades (more specifically, two net blades 511, two finishing net blades 521, and one slit outer blade 531) are made of ferromagnetic stainless steel (hereinafter, may be referred to as “SUS”). In this way, protective cap C is detachably attached to device main body B by using a magnetic attraction force generated between magnet 63 and the outer blade of blade part E. As described above, in the present exemplary embodiment, magnet 63 is provided in protective cap C, and the outer blade of blade part E is made of a ferromagnetic material such as metal. Thus, protective cap C is detachably attached to device main body B by using an attractive force (more specifically, magnetic attraction force generated between magnet 63 and the outer blade of blade part E) of magnet 63.

Note that, in the present exemplary embodiment, protective cap C is detachably attached to device main body B by using a magnetic attractive force generated between slit outer blade 531 having relatively high rigidity (that is, resistant to deformation) and magnet 63. In this way, deformation of the outer blade of blade part E can be more reliably suppressed.

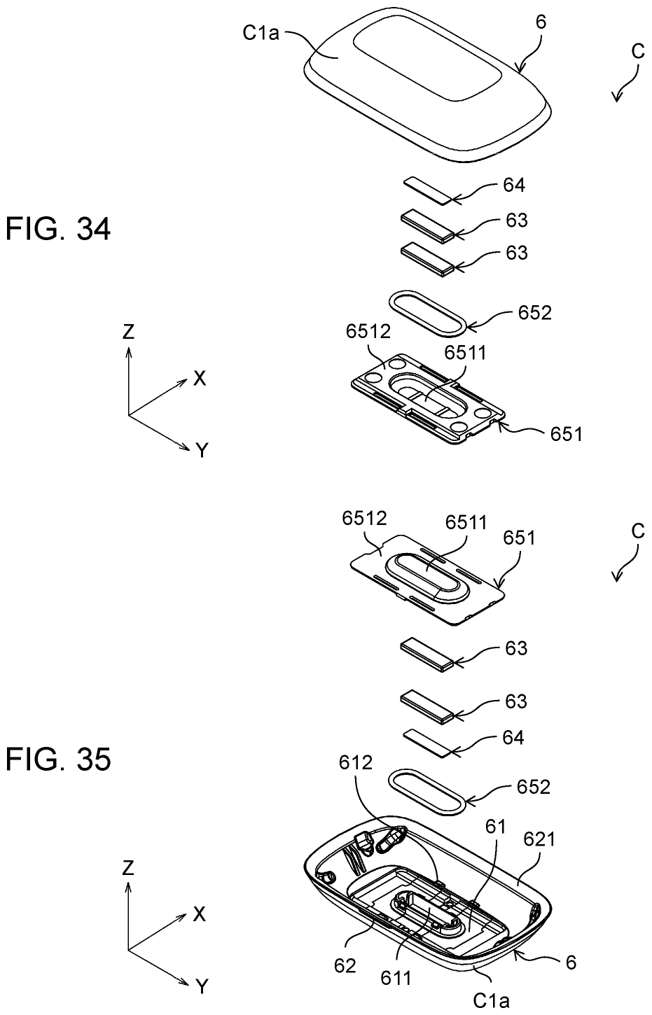

FIG. 34 is an exploded perspective view of protective cap C as viewed from above on the front side. FIG. 35 is an exploded perspective view of protective cap C as viewed from below on the back side. In the present exemplary embodiment, as illustrated in FIGS. 34 and 35, protective cap C includes protective cap main body 6 curved to protrude upward, and magnet 63 is attached to an inside of protective cap main body 6.

Further, in the present exemplary embodiment, as illustrated in FIGS. 36 to 39, protective-cap-side waterproof space S5 is formed in protective cap C, and magnet 63 is disposed inside protective-cap-side waterproof space S5. In this way, coming of a liquid such as water into contact with magnet 63 is suppressed.

Specifically, as illustrated in FIG. 35, a waterproof cover accommodation recess 61 capable of accommodating waterproof cover 651 is formed inside protective cap main body 6. Further, annular protrusion 611 elongated in the width direction and protrusion 612 for suppressing detachment of waterproof cover 651 are formed in waterproof cover accommodation recess 61.

Then, cushion 64 and two magnets 63 are inserted in this order inside annular protrusion 611, and waterproof cover 651 is accommodated in waterproof cover accommodation recess 61 in a state where O-ring 652 is interposed between annular protrusion 611 and waterproof cover 651. Thus, protective-cap-side waterproof space S5 is formed in protective cap C.

In the present exemplary embodiment, covering portion 6511 of waterproof cover 651 covers annular protrusion 611 in which cushion 64 and two magnets 63 are inserted in a state where O-ring 652 is interposed therebetween. In this way, protective-cap-side waterproof space S5 is formed. Flange portion 6512 formed around covering portion 6511 is pressed with protrusion 612, and thus, waterproof cover 651 is prevented from being detached from protective cap main body 6.

In this way, protective cap C is attached to device main body B only by covering device main body B with protective cap C.

At this time, distance L5 between magnet 63 attached to protective cap C and the outer blade (more specifically, slit outer blade 531) is set to be a desired distance, and thus, it is possible to set a detachment force of protective cap C to device main body B to be a desired detachment force.

Note that, in a state where protective cap C is attached to device main body B, it is preferable that distance L5 between magnet 63 and the outer blade (more specifically, slit outer blade 531) is greater than zero. That is, it is preferable that magnet 63 and slit outer blade 531 are separated from each other.

For example, when protective cap C is attached to device main body B, and when magnet 63 is brought into contact with (more specifically, is adsorbed to) the outer blade (more specifically, slit outer blade 531), the outer blade (more specifically, slit outer blade 531) may be damaged when electric razor A falls down, when protective cap C is removed from device main body B. However, as in the present exemplary embodiment, in a case where magnet 63 is separated from the outer blade (more specifically, slit outer blade 531) after protective cap C is attached to device main body B, the outer blade (more specifically, slit outer blade 531) can be prevented from being damaged when protective cap C is removed from device main body B, in case where electric razor A falls.

In addition, in the present exemplary embodiment, lower end surface 621 of protective cap main body 6 is an inclined surface inclined inward and upward, and upper end surface 151b of peripheral wall 151 of upper base housing 15 is an inclined surface inclined inward and upward at an angle corresponding to lower end surface 621 of protective cap main body 6. In this way, when protective cap main body 6 is held to pinch protective cap main body 6 from the front and the rear to apply an inner force, the protective cap main body moves in a direction of being detached from device main body B while being guided by upper end surface 151b. Accordingly, it is possible to more reliably suppress damage of blade part E when protective cap C is detachably attached to device main body B.

Note that, in the present exemplary embodiment, operation protrusion 62 is provided at a lower end of a rear portion of protective cap main body 6, and protective cap C can be detachably attached to device main body B by operating operation protrusion 62.

In addition, in the present exemplary embodiment, although it has been described that only one rechargeable battery having the same shape as the dry battery and compatible with the dry battery is used, a plurality of batteries 34 may be disposed in first space S1. An example of the rechargeable battery compatible with the dry battery is a rechargeable battery having a dry battery shape.

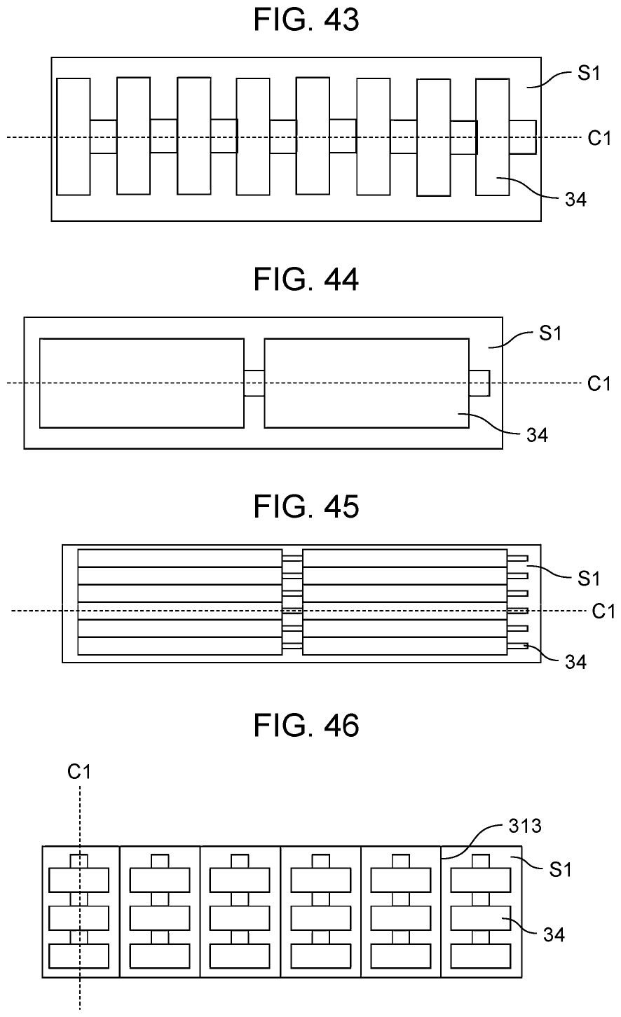

FIG. 42 is a diagram schematically illustrating a method for disposing battery 34 according to a first modification. FIG. 43 is a diagram schematically illustrating a method for disposing battery 34 according to a second modification. FIG. 44 is a diagram schematically illustrating a method for disposing battery 34 according to a third modification. FIG. 45 is a diagram schematically illustrating a method for disposing battery 34 according to a fourth modification. FIG. 46 is a diagram schematically illustrating a method for disposing battery 34 according to a fifth modification. For example, as illustrated in FIG. 42, a plurality of dry-battery-type batteries 34 may be lined up in the width direction (that is, first direction) in a state where central axis C1 extends in a direction (that is, up-down direction) orthogonal to the width direction (that is, first direction), and thus, batteries 34 are disposed inside first space S1.

In addition, as illustrated in FIG. 43, a plurality of button-battery-type batteries 34 may be lined in the width direction (that is, first direction) in a state where central axis C1 extends in a direction parallel to the width direction (that is, first direction), and thus, batteries 34 may be disposed in first space S1.

In addition, as illustrated in FIG. 44, a plurality of dry-battery-type batteries 34 may be lined up in the width direction (first direction) in a state where central axis C1 extends in a direction parallel to the width direction (that is, first direction), and thus, batteries 34 may be disposed in first space S1.

In addition, as illustrated in FIG. 45, a plurality of laminated-battery-type batteries 34 may be vertically laminated while being lined up in the width direction (that is, first direction) in a state where central axis C1 extends in a direction parallel to the width direction (that is, first direction), and thus, batteries 34 may be disposed in first space S1.

In addition, as illustrated in FIG. 46, a plurality of button-battery-type batteries 34 may be lined up in the width direction (that is, first direction) while being laminated in the up-down direction in a state where central axis C1 extends in a direction (that is, up-down direction) orthogonal to the width direction (that is, first direction), and thus, batteries 34 may be disposed in first space S1. Then, partition wall 313 may be formed between each pair.

As described above, batteries 34 can be disposed inside first space S1 in a state where central axis C1 extends in the direction parallel or orthogonal to the width direction (that is, first direction). Accordingly, although not illustrated, batteries 34 may be disposed inside first space S1 in a state where central axis C1 extends in the direction (that is, front-back direction) orthogonal to the width direction (that is, first direction).

In this way, for example, in a case where an assembled battery is constituted by the plurality of batteries 34, since individual batteries 34 are laid vertically or horizontally, a space in which batteries 34 are disposed can be minimized. That is, since the space of first space S1 can be more effectively used, a volume of first space S1 can be minimized.

### Actions and Effects

Hereinafter, a characteristic configuration of the depilatory device described in the above exemplary embodiment and the modifications thereof, and effects obtained by the characteristic configuration will be described.

(Technology 1) Electric razor A (that is, an example of the depilatory device) described in the above exemplary embodiment and the modifications thereof includes base D (that is, an example of the main body), blade part E provided at base D (that is, an example of the main body) and capable of removing beard (that is, an example of hair), and linear motor 43 (that is, an example of the motor) built in base D (that is, an example of the main body) and drives blade part E. In addition, first space S1 in which battery 34 capable of supplying electric power to linear motor 43 (that is, an example of the motor) is disposed is formed in base D (that is, an example of the main body).

First space S1 has a shape elongated in the width direction (first direction) extending in the horizontal direction in a state where blade part E and base D (that is, an example of the main body) are lined up in the up-down direction, and linear motor 43 (that is, an example of the motor) is built in base D (that is, an example of the main body) in a state of being elongated in the direction extending in the horizontal direction.

In this way, since first space S1 formed in base D (that is, an example of the main body) is horizontally long (that is, a space elongated in the width direction) and linear motor 43 (that is, an example of the motor) is also built in base D (that is, an example of the main body) in the horizontally long state (that is, a state of being elongated in the width direction), it is possible to suppress the spreading of base D (that is, an example of the main body) in the longitudinal direction (that is, up-down direction). As a result, the dimension of electric razor A (that is, an example of the depilatory device) in the height direction (that is, the vertical direction and the up-down direction) can be further reduced.

As described above, according to the configuration described in the above exemplary embodiment and the modifications thereof, since electric razor A (that is, an example of the depilatory device) can be further downsized, electric razor A can be stored without taking up much space. In addition, even in a case where electric razor A which is small is put in a bag or the like, since electric razor A does not become a hindrance so much. Therefore, for example, when the user goes out on a trip or the like, electric razor A (that is, an example of the depilatory device) can be more easily carried.

In addition, electric razor A (that is, an example of the depilatory device) described in the above exemplary embodiment and the modifications thereof can be disposed on a desk or the like without taking up much space. Therefore, electric razor A (that is, an example of the depilatory device) can be used as the interior of the room when electric razor A is not in use. When electric razor A (that is, an example of the depilatory device) is decorated in the room, and while the user does some work in the room, in a case where the user wants to use electric razor A (that is, an example of the depilatory device), since it is not necessary for the user to move to a place where the electric razor (that is, an example of the depilatory device) is generally accommodated, such as a wash basin, the user can more easily use electric razor A (that is, an example of the depilatory device).

Further, when the dimension in the height direction (that is, the vertical direction and the up-down direction) of electric razor A (that is, an example of the depilatory device) is reduced, the fingertip can be positioned near blade part E when peripheral wall 12 of base D (that is, an example of the main body) is held by finger U22 in a state where bottom surface 111 of base D (that is, an example of the main body) faces palm U21. Thus, in a case where electric razor A (that is, an example of the depilatory device) is used in a state where peripheral wall 12 of base D (that is, an example of the main body) is held by finger U22 while bottom surface 111 of base D (that is, an example of the main body) faces palm U21, it is possible to more reliably suppress the shaking of electric razor A (that is, an example of the depilatory device). That is, even in a case where electric razor A (that is, an example of the depilatory device) is used in a state where base D (that is, an example of the main body) is wrapped with hand U2, the deterioration of operability can be suppressed.

As described above, electric razor A (that is, an example of the depilatory device) described in the above exemplary embodiment and the modifications thereof can be used in a state where base D (that is, an example of the main body) is gripped by various methods.

(Technology 2) In addition, in the above (Technology 1), linear motor 43 (that is, an example of the motor) may be built in base D (that is, an example of the main body) in a state of being elongated in the width direction (that is, first direction).

In this way, it is possible to reduce the thickness of electric razor A (that is, an example of the depilatory device) (that is, to shorten the length in the front-back direction) while the downsizing of electric razor A (that is, an example of the depilatory device) in the height direction (that is, the vertical direction and the up-down direction) is achieved.

(Technology 3) In addition, in the above (Technology 1) or (Technology 2), battery 34 may be built in base D (that is, an example of the main body).

In this way, linear motor 43 (that is, an example of the motor) and battery 34 are disposed inside the waterproof space, and in a case where electric razor A (that is, an example of the depilatory device) has the waterproof function, battery 34 can be disposed in a state where the battery is not allowed to be taken out from the waterproof space. Thus, it is possible to more reliably suppress deterioration in waterproof performance of electric razor A (that is, an example of the depilatory device).

(Technology 4) In addition, in the above (Technology 1) or (Technology 2), base D (that is, an example of the main body) may be configured to take in and out battery 34 to and from first space S1.

In this way, it is possible to more easily replace battery 34 that has become unusable due to a lifespan or the like with new battery 34.

(Technology 5) In addition, in any technology of the above (Technology 1) to (Technology 4), blade part E may include an outer blade (more specifically, net blade 511, finishing net blade 521, or slit outer blade 531) configured to protect skin U1, and an inner blade (more specifically, net inner blade 512, finishing net inner blade 522, or slit inner blade 532) driven by the motor and configured to relatively move with respect to outer blade (more specifically, net blade 511, finishing net blade 521, or slit outer blade 531). Blade part E may be provided such that the inner blade (more specifically, net inner blade 512, finishing net inner blade 522, or slit inner blade 532) reciprocates linearly with respect to the outer blade (more specifically, net blade 511, finishing net blade 521, or slit outer blade 531). Further, the motor may be linear motor 43.

As described above, when reciprocating-type electric razor A (that is, an example of the depilatory device) is used, it is possible to secure a large cutting region of the beard (that is, an example of hair) while the downsizing in the front-back direction (that is, depth direction, more specifically, reciprocating direction of the inner blade) is achieved.

Note that, when rotary electric razor A (that is, an example of the depilatory device) is used, since a contour shape of one outer blade is substantially circular, in a case where the plurality of outer blades are lined up in the width direction, the downsizing in the front-back direction (that is, depth direction) can be achieved. However, in a case where the substantially circular outer blades are lined up in the width direction, since a region where the beard (that is, an example of hair) cannot be cut is formed between the adjacent outer blades, a large cutting region of the beard (that is, an example of hair) cannot be secured. On the other hand, when the plurality of outer blades are lined up along a circumference, it is possible to secure a large cutting region of the beard (that is, an example of hair), but the outer blade becomes large in the front-back direction (that is, depth direction, more specifically, reciprocating direction of the inner blade).

As described above, in a case where rotary electric razor A (that is, an example of the depilatory device) is used, both the downsizing in the front-back direction (that is, depth direction, more specifically, reciprocating direction of the inner blade) and the securing of the cutting region of the beard (that is, an example of hair) cannot be achieved. However, in a case where reciprocating-type electric razor A (that is, an example of the depilatory device) is used, both the downsizing in the front-back direction (that is, depth direction, more specifically, reciprocating direction of the inner blade) and the securing of the cutting area for the beard (that is, an example of hair) can be achieved.

In addition, when reciprocating-type electric razor A (that is, an example of the depilatory device) is provided by using a rotary motor, since a mechanism for converting rotational motion of the motor into reciprocating linear motion of the inner blade is required, the size of the device may increase, or manufacturing cost may increase.

On the other hand, when reciprocating-type electric razor A (that is, an example of the depilatory device) is provided by using linear motor 43, since the motion (as one example, reciprocating linear motion) of linear motor 43 is directly transmitted to the inner blade (more specifically, net inner blade 512, finishing net inner blade 522, or slit inner blade 532), it is not necessary to separately provide the conversion mechanism. As a result, it is possible to suppress the increase in manufacturing cost while the increase in size of the device is suppressed.

(Technology 6) In addition, in any technology of the above (Technology 1) to (Technology 5), battery 34 may be disposed inside first space S1 in a state where central axis C1 extends in a direction parallel or orthogonal to the width direction (that is, first direction).

In this way, for example, in a case where an assembled battery is constituted by the plurality of batteries 34, since individual batteries 34 are laid vertically or horizontally, a space in which batteries 34 are disposed can be minimized. That is, since the space of first space S1 can be more effectively used, a volume of first space S1 can be minimized.

(Technology 7) In addition, in any technology of the above (Technology 1) to (Technology 6), device main body B including base D (that is, an example of the main body) and blade part E may have length L1 in the up-down direction shorter than length L2 in the width direction (that is, first direction) in a state where blade part E and the main body D are lined up in the up-down direction.

In this way, when peripheral wall 12 of base D (that is, an example of the main body) is held by finger U22 in a state where bottom surface 111 of base D (that is, an example of the main body) faces palm U21, the fingertip can be more reliably positioned near blade part E. In addition, when peripheral wall 12 of base D (that is, an example of the main body) is held by finger U22 in a state where bottom surface 111 of base D (that is, an example of the main body) faces palm U21, the center of gravity of device main body B can be positioned closer to palm U21 than the fingertip. That is, base D (that is, an example of the main body) can be gripped in a state where the center of gravity of device main body B is wrapped by hand U2.

As a result, in a case where electric razor A (that is, an example of the depilatory device) is used in a state where base D (that is, an example of the main body) is wrapped with hand U2, it is possible to more reliably suppress the shaking of electric razor A (that is, an example of the depilatory device).

(Technology 8) In addition, in any technology of the above (Technology 1) to (Technology 7), in a case where a direction orthogonal to the up-down direction and the width direction (that is, first direction) is a front-back direction (that is, second direction), first space S1 may be formed at a central portion of base D (that is, an example of the main body) in the front-back direction (that is, second direction).

In this way, since the biasing of the center of gravity of device main body B to one side in the front-back direction (that is, second direction) is suppressed, it is possible to further improve the operability when electric razor A (that is, an example of the depilatory device) is in use.

In addition, members (for example, circuit board or the like) other than battery 34 can be disposed on both sides of base D (that is, an example of the main body) in the front-back direction (that is, second direction). As described above, when members (for example, circuit board or the like) other than battery 34 can be disposed on both sides of base D (that is, an example of the main body) in the front-back direction (that is, second direction), balances in front and back of base D (that is, an example of the main body) can be adjusted by appropriately selecting members to be disposed in front and back of first space S1. In addition, when members (for example, circuit board or the like) other than battery 34 can be disposed on both sides of base D (that is, an example of the main body) in the front-back direction (that is, second direction), since the number of members disposed above and below first space S1 is reduced, the downsizing of base D (that is, an example of the main body) in the height direction can be achieved.

(Technology 9) In addition, in any technology of the above (Technology 1) to (Technology 8), electric razor A (that is, an example of the depilatory device) may include device main body B including base D (that is, an example of the main body) and blade part E, and protective cap C detachably attached to device main body B to protect blade part E. Protective cap C may be attached to device main body B by a magnetic force.

In this way, it is possible to protect blade part E with protective cap C without providing unevenness (more specifically, mechanical fixed shape) capable of being engaged with protective cap C in base D (that is, an example of the main body). As described above, when the unevenness (more specifically, mechanical fixed shape) is not provided in base D (that is, an example of the main body), unlike a case where the unevenness (more specifically, mechanical fixed shape) is provided in base D (that is, an example of the main body), since it is possible to suppress the catching of finger U22 on the unevenness when electric razor A (that is, an example of the depilatory device) is in use, it is possible to further improve the operability when electric razor A (that is, an example of the depilatory device) is in use.

(Technology 10) In addition, in the above (Technology 9), protective-cap-side waterproof space S5 may be formed in protective cap C, and magnet 63 may be disposed inside protective-cap-side waterproof space S5.

In this way, since coming of the liquid such as water into contact with magnet 63 is suppressed, rust of magnet 63 can be suppressed. As a result, adhesion of the rust (for example, red rust) of magnet 63 to blade part E can be suppressed, and discomfort given to skin U1 when electric razor A (that is, an example of the depilatory device) is in use can be suppressed.

(Technology 11) In addition, in any technology of the above (Technology 1) to (Technology 10), switch button 13 (that is, an example of the operator) configured to switch between on and off of a power supply may be formed on bottom wall 11 of base D (that is, an example of the main body) disposed in a state where blade part E is positioned at an upper portion and base D (that is, an example of the main body) is positioned at a lower portion.

In this way, it is possible to more reliably suppress the erroneous operation of switch button 13 (that is, an example of the operator) when base D (that is, an example of the main body) is gripped.

(Technology 12) In addition, in the above (Technology 11), second space S2 may be formed between bottom wall 11 and mounting surface 7a when the main body is mounted on mounting surface 7a in a state where bottom wall 11 faces downward.

In this way, when electric razor A (that is, an example of the depilatory device) is mounted on mounting surface 7a, it is possible to more reliably suppress the interference of switch button 13 (that is, an example of the operator) with mounting surface 7a. As a result, when electric razor A (that is, an example of the depilatory device) is mounted on mounting surface 7a, it is possible to suppress the operation of switch button 13 (that is, an example of the operator) by mounting surface 7a to switch between on and off the power supply.

(Technology 13) In addition, in the above (Technology 12), second space S2 may be a non-closed space.

In this way, even in a case where electric razor A (that is, an example of the depilatory device) is mounted on mounting surface 7a in a state where the liquid adheres to bottom wall 11, bottom wall 11 can be more quickly dried.

(Technology 14) In addition, in any technology of the above (Technology 1) to (Technology 13), main-body-side waterproof space S3 in which motor 43 and battery 34 are disposed may be formed in base D (that is, an example of the main body).

In this way, blade part E can be washed with water, or electric razor A (that is, an example of the depilatory device) can be used in a bathroom or the like. Accordingly, the usability of electric razor A (that is, an example of the depilatory device) can be further improved.

(Technology 15) In addition, in the above (Technology 14), non-waterproof space S4 may be formed outside main-body-side waterproof space S3 in base D (that is, an example of the main body). Discharge port S4a configured to discharge a liquid present inside non-waterproof space S4 to an outside may be formed at a lower end of base D (that is, an example of the main body) in a state where blade part E is positioned at an upper portion and base D (that is, an example of the main body) is positioned at a lower portion.

In this way, the liquid entering non-waterproof space S4 can be more quickly discharged to the outside.

(Technology 16) In addition, in any technology of the above (Technology 1) to (Technology 15), USB terminal 3332 (that is, an example of the charging unit) into which USB cable 8 (that is, an example of the charging code) can be inserted may be formed on peripheral wall 12 of base D (that is, an example of the main body) disposed in a state where blade part E is positioned at an upper portion and base D (that is, an example of the main body) is disposed at a lower portion.

In this way, since battery 34 can be charged in a state where electric razor A (that is, an example of the depilatory device) is mounted on mounting surface 7a, the usability of electric razor A (that is, an example of the depilatory device) can be further improved.

(Technology 17) In addition, in the above (Technology 16), base D (that is, an example of the main body) may include USB cap 14 (that is, an example of the cap) openably covering USB terminal 3332 (that is, an example of the charging unit) in an openable and closable way.

In this way, since contact of hand U2 with USB terminal 3332 (that is, an example of the charging unit) is suppressed when electric razor A (that is, an example of the depilatory device) is in use, it is possible to further improve the operability when electric razor A (that is, an example of the depilatory device) is in use.

In addition, since USB terminal 3332 (that is, an example of the charging unit) can be protected by USB cap 14 (that is, an example of the cap) when battery 34 is not charged, it is possible to more reliably suppress the damage of USB terminal 3332 (that is, an example of the charging unit).

(Technology 18) In addition, in any technology of the above (Technology 1) to (Technology 17), light guide unit 323 (that is, an example of the display unit) may be formed at a coupling portion of peripheral wall 12 of base D (that is, an example of the main body) with bottom wall 11 in a state where blade part E is positioned at an upper portion and base D (that is, an example of the main body) is positioned at a lower portion.

In this way, since light guide unit 323 (that is, an example of the display unit) is formed at a portion of base D (that is, an example of the main body) that is not very noticeable, electric razor A (that is, an example of the depilatory device) in which light guide unit 323 (that is, an example of the display unit) can visually be recognized while the design property is improved can be obtained.

At this time, it is preferable that light guide unit 323 (that is, an example of the display unit) is formed near switch button 13 (that is, an example of the operator). In this way, when switch button 13 (that is, an example of the operator) is operated, since the light emitted to the outside from light guide unit 323 (that is, an example of the display unit) can be easily visually recognized, the operation state (for example, an energized state or the like) of switch button 13 (that is, an example of the operator) can be more easily confirmed.

### Others

Although the contents of the depilatory device according to the present disclosure have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the above exemplary embodiment and the modifications thereof are made. In addition, it is also possible to make a new exemplary embodiment by combining the constituent elements described in the above exemplary embodiment and the modifications thereof.

In addition, in the above exemplary embodiment and the modifications thereof, although it has been described that electric razor A (that is, an example of the depilatory device) including protective cap C is used, the present disclosure is also applicable to an electric razor (that is, an example of the depilatory device) not including a protective cap.

In addition, in the above exemplary embodiment and the modifications thereof, although it has been described that first space S1 elongated in the Y direction (that is, width direction) is used, first space S1 may be elongated in any direction as long as the first space extends in the horizontal direction in a state where blade part E and base D (that is, an example of the main body) are lined up in the up-down direction. That is, first space S1 may be formed such that the length in the horizontal direction is longer than the length in the vertical direction when electric razor A in a state where blade part E and base D (that is, an example of the main body) are lined up in the up-down direction is viewed from any direction parallel to the horizontal direction. Accordingly, first space S1 can have an L-shape in plan view.

In addition, the configuration for attaching protective cap C to device main body B is not limited to the configuration described in the above exemplary embodiment and the modifications thereof, and various configurations can be adopted. For example, unevenness to be engaged with each other may be provided in protective cap C and device main body B, and protective cap C may be attached to device main body B by mechanical engagement.

In addition, in the above exemplary embodiment and the modifications thereof, although it has been described that the inner blade (more specifically, net inner blade 512, finishing net inner blade 522, or slit inner blade 532) reciprocates linearly with respect to the outer blade (more specifically, net blade 511, finishing net blade 521, or slit outer blade 531) as the depilatory device, the present disclosure is also applicable to a depilatory device in which the inner blade is relatively rotated with respect to the outer blade.

In addition, in the above exemplary embodiment and the modifications thereof, although it has been described that electric razor A (that is, an example of the depilatory device) in which main body D has a waterproof structure, the present disclosure is also applicable to an electric razor (that is, an example of the depilatory device) in which main body D does not have the waterproof structure. In this case, it is also possible to dispose the magnet attached to the protective cap in a non-waterproof space.

In addition, in the above exemplary embodiment and the modifications thereof, although it has been described that switch button 13 (that is, an example of the operator) which can switch between on and off of the power supply is formed on bottom wall 11 of main body D, the present disclosure is not limited to such a configuration, and a switch button (that is, an example of the operator) may be formed on a peripheral wall.

In addition, in the above exemplary embodiments and the modifications thereof, although it has been described that charging unit 3332 into which USB cable 8 (that is, an example of the charging code) can be inserted is formed in peripheral wall 12 of main body D, the present disclosure is not limited to such a configuration, and it is also possible to form the charging unit on the bottom wall.

In addition, in the above exemplary embodiment and the modifications thereof, although it has been described that electric razor A (that is, an example of the depilatory device) having five blades is used, the number of blades is not limited to five, and may be one to four, or six or more.

In addition, in the above exemplary embodiment and the modification thereof, although it has been described that electric razor A that cuts beard is used as the depilatory device, the present disclosure is applicable not only to electric razor A but also to various types of depilatory device. For example, the present disclosure can be applied to trimers (more specifically, electric hair-cutting device) that cut human or animal body hair or hair, or the present disclosure can be applied to hair removal devices that remove human or animal hair (that is, an example of depilatory).

In addition, specifications of the main body, the blade part, and other details (for example, a shape, a size, a layout, and the like) can be changed as appropriate.

As described above, since the depilatory device according to the present disclosure can be further downsized, the depilatory device can be applied not only to the beard but also to various hair treatments.

What is claimed is:

1. A depilatory device comprising:
a main body;
a blade part that is provided at the main body, the blade part being configured to remove hair; and
a motor that is built in the main body, and drives the blade part,
wherein
a first space in which a battery configured to supply electric power to the motor is disposed is provided in the main body,
the first space has a shape elongated in a first direction extending in a horizontal direction in a state where the blade part and the main body are lined up in an up-down direction, and
the motor is built in the main body in a state of being elongated in a direction extending in the horizontal direction.

2. The depilatory device according to claim 1, wherein
the motor is built in the main body in a state of being elongated in the first direction.

3. The depilatory device according to claim 1, wherein
the battery is built in the main body.

4. The depilatory device according to claim 1, wherein
the main body is configured to take in and out the battery to and from the first space.

5. The depilatory device according to claim 1, wherein
the blade part comprises:
an outer blade configured to protect skin, and
an inner blade driven by the motor, the inner blade being configured to relatively move with respect to the outer blade,
wherein
the blade part is configured in such a manner that the inner blade reciprocates linearly with respect to the outer blade, and
the motor is a linear motor.

6. The depilatory device according to claim 1, wherein
the battery is disposed inside the first space in a state where a central axis of the battery extends in a direction parallel or orthogonal to the first direction.

7. The depilatory device according to claim 1, wherein
a device main body comprising the main body and the blade part has a length in an up-down direction shorter than a length in the first direction in a state where the blade part and the main body are line up in the up-down direction.

8. The depilatory device according to claim 1, wherein
the first space is formed at a central portion of the main body in a second direction, the second direction being a direction orthogonal to the up-down direction and the first direction.

9. The depilatory device according to claim 1, further comprising:
a device main body comprising the main body and the blade part; and
a protective cap detachably attached to the device main body to protect the blade part,
wherein
the protective cap is attached to the device main body by magnetic force.

10. The depilatory device according to claim 9, wherein
a protective-cap-side waterproof space is formed in the protective cap, and
a magnet is disposed inside the protective-cap-side waterproof space.

11. The depilatory device according to claim 1, wherein
an operator configured to switch between on and off of a power supply is formed on a bottom wall of the main body disposed in a state where the blade part is positioned at an upper portion and the main body is positioned at a lower portion.

12. The depilatory device according to claim 11, wherein
a second space is provided between the bottom wall and a mounting surface when the main body is mounted on the mounting surface in a state where the bottom wall faces downward.

13. The depilatory device according to claim 12, wherein
the second space is a non-closed space.

14. The depilatory device according to claim 1, wherein
a main-body-side waterproof space in which the motor and the battery are disposed is formed in the main body.

15. The depilatory device according to claim 14, wherein
a non-waterproof space is formed outside the main-body-side waterproof space in the main body, and
a discharge port through which a liquid present inside the non-waterproof space is configured to be discharged to an outside is provided at a lower end of the main body disposed in a state where the blade part is positioned at an upper portion and the main body is positioned at a lower portion.

16. The depilatory device according to claim 1, wherein
a charging unit into which a charging code is configured to be inserted is provided on a peripheral wall of the main body disposed in a state where the blade part is positioned at an upper portion and the main body is positioned at a lower portion.

17. The depilatory device according to claim 16, wherein
the main body comprises a cap covering the charging unit in an openable and closable way.

18. The depilatory device according to claim 1, wherein
a display unit is provided at a coupling portion of a peripheral wall of the main body with a bottom wall in a state where the blade part is positioned at an upper portion and the main body is positioned at a lower portion.
